(19) United States
(12) Patent Application Publication
(10) Pub. No.: US 2026/0148089 A1
(43) Pub. Date: May 28, 2026

(54) FEDERATED DOCUMENT LEARNING

(71) Applicant: Docusign, Inc., San Francisco, CA (US)

(72) Inventors: Yangcheng Huang, Dublin (IE); Souleiman Hasan, Dublin (IE); Karthikeyan Jawahar, Dublin (IE)

(73) Assignee: Docusign, Inc., San Francisco, CA (US)

(21) Appl. No.: 18/958,992

(22) Filed: Nov. 25, 2024

(51) Int. Cl. G06N 3/098

(52) U.S. Cl. CPC G06N 3/098

(57) ABSTRACT

A method, a system, and a computer program product for federated document learning. A plurality of representations of a plurality of datasets from a plurality of client systems are received. Each representation corresponds to a dataset associated with a client system and is generated using a first machine learning (ML) model. A second ML model is applied to the plurality of representations to generate a combined representation of the plurality of datasets. Data from each dataset is not provided to the second ML model. The combined representation is filtered using one or more filtering parameters to generate a filtered representation. Using the second ML model, one or more model weights for training a third ML model in a plurality of third ML models are generated. Each third ML model is associated with a respective client system. The model weights are provided to the plurality of third ML models.

### BACKGROUND

The accuracy of machine learning models, such as classification models, can benefit from increased exposure to a disparate set of training data. Further, using trained machine learning models to make predictions on new data can provide insights regarding issues of accuracy for the trained machine learning models. In cases where different parties use machine learning models to perform related tasks, the accuracy of the models used could be improved by shared access to private data or model prediction results. However, different parties with access to disparate sets of private data, or using custom machine learning techniques, may be hesitant to allow their private data or techniques to be used for training models that may be used by other parties. Conventional systems are unable to perform federated learning of parties' documents so that it may provide such parties with appropriate training weights and/or parameters for training of their models.

### BRIEF DESCRIPTION OF THE DRAWINGS

To easily identify the discussion of any particular element or act, the most significant digit or digits in a reference number refer to the figure number in which that element is first introduced.

FIG. 1 illustrates a system in accordance with one embodiment.

FIG. 2 illustrates an example computing system that may be used for federated document learning, according to some embodiments of the current subject matter.

FIG. 3 illustrates an example system showing operation of the federated document learning engine, according to some embodiments of the current subject matter.

FIG. 4 illustrates an example client system that may be used to generate one or more representation(s), according to some embodiments of the current subject matter.

FIG. 5 illustrates an example client dataset(s), according to some embodiments of the current subject matter.

FIG. 6 illustrates an example of client dataset(s), according to some embodiments of the current subject matter.

FIG. 7 illustrates an example filtering process that may be performed by the federated document learning engine, according to some embodiments of the current subject matter.

FIG. 8 illustrates an example process for federated document learning, according to some embodiments of the current subject matter.

FIG. 9 illustrates an example of an AI/ML system that may be used for generating one or more transaction packages and/or guiding the user through one or more tasks, documents, etc., according to some embodiments of the current subject matter.

FIG. 10 illustrates an example apparatus that may include a training device suitable to generate a trained ML model for the inferencing device of the system shown in FIG. 9.

FIG. 11 illustrates an artificial intelligence architecture that may be used by the training device to generate the ML model (e.g., as shown in FIG. 1) for deployment by the inferencing device.

FIG. 12 illustrates an artificial neural network, according to some embodiments of the current subject matter.

FIG. 13 illustrates a document corpus, according to some embodiments of the current subject matter.

FIG. 14 illustrates electronic documents, according to some embodiments of the current subject matter.

FIG. 15 illustrates an example method for performing federated document learning, according to some embodiments of the current subject matter.

FIG. 16 illustrates another example method for performing federated document learning, according to some embodiments of the current subject matter.

FIG. 17 illustrates yet another example method for performing federated document learning, according to some embodiments of the current subject matter.

FIG. 18 illustrates a computer-readable storage medium in accordance with one embodiment.

FIG. 19 illustrates a computing architecture in accordance with one embodiment.

FIG. 20 illustrates a communications architecture in accordance with one embodiment.

### DETAILED DESCRIPTION

Embodiments disclosed herein are generally directed to techniques for federated document learning, such as, for example, to enable training of client-specific machine learning models using model weights generated by a centralized model without accessing client-specific data. Such federated document learning is assisted through use of machine learning models and artificial intelligence architectures. In general, a document may include a multimedia record. The term “electronic” may refer to technology having electrical, digital, magnetic, wireless, optical, electromagnetic, or similar capabilities. The term “electronic document” may refer to any electronic multimedia content intended to be used in an electronic form. An electronic document may be part of an electronic record. The term “electronic record” may refer to a contract or other record created, generated, sent, communicated, received, or stored by an electronic mechanism. An electronic document may have an electronic signature. The term “electronic signature” may refer to an electronic sound, symbol, or process, attached to or logically associated with an electronic document, such as a contract or other record, and executed or adopted by a person with the intent to sign the record.

An online electronic document management system provides a host of different benefits to users (e.g., a client or customer) of the system. One advantage is added convenience in generating and signing an electronic document, such as a legally binding agreement. Parties to an agreement can review, revise and sign the agreement from anywhere around the world on a multitude of electronic devices, such as computers, tablets and smartphones.

In some embodiments, the current subject matter relates to executing federated electronic document learning by a centralized federated document learning system (or “centralized system”, “centralized learning system”, “federated system”, “federated learning system”, and/or any variations thereof, where these terms are used interchangeably herewith). The electronic documents may be stored (and/or otherwise located, accessible by, etc.) in client systems and may be shielded from access by the centralized system. Each client system's electronic documents may also be shielded from being accessed by another client system.

Shielding of client system's data may ensure that privacy of client system's data is maintained and protected from exposure. This may serve as a data protection mechanism (DPM). A DPM may focus on data security, data rights, and/or privacy. Examples of technical DPM include software configurations to encrypt, anonymize and/or disaggregate data from sources. Examples of regulatory DPMs include GDPR (General Data Protection Regulation) and CCPA (California Consumer Privacy Act)). A DPM may make it difficult to train models and artificial intelligence (AI) because of privacy and security concerns that may be associated with information breaches. The current subject matter can apply to other scenarios in which training models are trained but the underlying data must be kept secure and removable by the client system that submitted the data or may not be otherwise disclosed.

Client systems are often only willing to submit information for model generation and training if it can be ensured that their data can be tracked and known at all times, and not exposed to third parties without expressed permission. In addition, each client system may need to have the ability to issue a destruction request to remove their data from the system and model, in conformance with right to be forgotten regulations. As such, a system cannot use the data within the training of models unless it can be controlled, tracked, destroyed and obfuscated for personal information or elements.

However, if each client system is only able to train a model on information that it has access to and can effectively track and, if required, revoke access to or destroy, the generated model may be over fitted to a small subset of information, limiting the benefits of the automation of information detection. This presents a difficult problem for the training of models for the detection of the widest possible information within the same category.

In order to effectively train a model, the learning platform should have access to as much disparate data as possible. This may be accomplished by using information from many different parties associated with respective client systems to train the model. For example, different client systems may have access to information (e.g., clauses) from different verticals and industries that detail the same concept or category, for example indemnity or assignment language, that collectively may form a large set of disparate data that can be used by the system for training the model for classifying the concept or category. By training the model on different sets of data received from different parties, a more comprehensive model can be generated in comparison to models only trained on data from a single party.

Client systems may store various data, including sensitive data and/or information, in one or more datasets, including structured and/or unstructured datasets. Such datasets may include contracts, agreements, commercial documentation, trade secret data or information, nonpublic data or information, confidential data or information, secret data or information, and/or any other type of data and/or information and/or any combination thereof. Such data and/or information may include information that an entity (e.g., a party to an agreement) may prefer to keep away from public disclosure and/or from disclosure to any unintended recipients. For instance, a trade secret (e.g., soft drink formula, trade secret manufacturing process, etc.), commercially sensitive data, and/or any other secret data may fall into the category of sensitive information. through use of a clustering/bucketing/grouping approach. As can be understood, any type of data may be stored by the client systems, including public data that may be connected to private client data and that the client system may not wish to expose.

The client data may be stored as, for example, electronic documents, text, graphics, images, tables, audio, video, computing code (e.g., source code, etc.) and/or any other type of media, etc. (hereinafter, “documents”) and may analyze the such collection of documents to identify documents in accordance with each type of sensitive data (e.g., a trade secret, commercially sensitive information, etc.). The data may be stored in any desired format (e.g., .pdf, .docx, etc.). Further, the documents may be any type of electronic documents, e.g., agreement types, legal document types, non-legal document types, and any combinations thereof. Moreover, portions of documents and/or documents (e.g., sales agreement, etc.) may be associated with other portions of and/or documents (e.g., master services agreement, etc.).

Each client system may include various machine learning (ML) models that may be used by the client system to process, analyze, and/or learn from the client's electronic documents. The machine learning models may need to be trained to ensure that they are able to correctly perform such processing, analysis, and learning. The training may be accomplished using one or more model weights that may be generated by the centralized system. For instance, the ML models may be used for the purposes of identification of sensitive data, where such model(s) may be trained using set(s) of data representing sensitive data (e.g., one ML model may be trained using trade secret data (e.g., recipe formula) and another model may be trained using confidential information (e.g., company employee names, addresses, etc. data)). As can be understood, a single ML model may be trained on different types of sensitive data representing different types of sensitive data and/or information. Thus, it is important to provide proper model weights for training such models to ensure that the models are providing adequate responses to queries. In some embodiments, the ML models may, for example, include at least one of the following: a large language model, a generative artificial intelligence (AI) model, and any combination thereof, where the generative AI models may be part of the current subject matter system and/or be one or more third party models (e.g., ChatGPT, Bard, DALL-E, Midjourney, DeepMind, etc.).

The centralized system may generate model weights based on one or more representations (e.g., hierarchical representation, a list representation, a catalog representation, etc.) of each client system's electronic documents, e.g., datasets. The representations may be of individual electronic documents and/or of all electronic documents stored by the client system. The representations may provide one or more structural arrangements of datasets, which may include types of electronic documents being stored (e.g., legal documents, non-legal documents, agreements (including types of agreements (e.g., NDAs, sales agreements, etc.), legal pleadings, books, articles, publications, etc.). The representations may be generated using one or more public models (e.g., publicly available models) that may be provided to the client systems for that purpose.

Upon receiving the public model(s), the client system may use the public model(s) to internally generate a representation of their datasets. Public model(s) may be specific to particular types of document(s), e.g., agreements, etc., and may be used to generate a hierarchical representation of the document and/or documents. For example, the hierarchical representation may include a tree-like arrangement of nodes with each node corresponding to a particular section within the agreement. While the representation will not include any specific data from the dataset, it may include various metadata that may help with generation of model weights by the centralized system. The metadata may include various identifiers, groupings, etc. that may be helpful in ascertaining type(s) of data, type(s) of electronic document, connection(s) among data (e.g., a termination clause in the agreement may be connected to a term clause in the same agreement, etc.), etc. without revealing specifics of the data. Such metadata may be used by the centralized model to determine model weights for training client models. As can be understood, the representation(s) may be in any desired form and/or structure.

In some embodiments, the centralized system may provide a specific public model that may be used for generation of a particular representation of the data in the client's dataset. For instance, the public model may be designed for generation of catalog type representations of the dataset. The public models of a particular type may be provided to all client systems and/or to specific client system (e.g., one client system may receive a public model that may be designed for generation of hierarchical type representations while another client system may receive a public model that may be designed for generation of a list type representations). Alternatively, or in addition, representations may be generated using at least one of: one or more previous learning and/or training tasks (e.g., prior learning queries, etc. (which may be the same and/or different as a current learning query)), client system's models, and/or generated in any other way based on the client datasets.

Once representations are generated, they may be provided to the centralized model of the centralized system for generation of one or more model weights (which is in contrast to existing system that generate model weights randomly), which, upon generation, may be provided to client systems for training of client system's respective models. The centralized system may use the centralized model to combine and/or group representations received from different client systems into a single combined representation. The centralized model may then perform filtering of the combined representation based on one or more first (e.g., coarse) filtering parameters. For example, the coarse filtering parameters may be related to removal of irrelevant type of data (e.g., a publication that may be unrelated to an agreement), certain types of data (e.g., forms, etc.), and/or generally noisy data that may affect generation of model weights. Coarse filtering of representations may result in generation of first filtered representations.

The first filtered representations may then be further filtered using second (e.g., fine) filtering parameters. The fine filtering parameters may be related to specific types of documents (e.g., NDAs, sales agreements, etc.), and/or specific representations that are being processed by the centralized model. Such parameters may be defined for a particular client system (e.g., a client system that may be interested in training its client model to process sales agreements only, etc.). Use of fine filtering parameters may allow for dynamic filtering or pruning of representations so that specific model weights may be generated.

Once fine filtering of representations has been completed, the centralized model may be configured to generate one or more model weights that may be provided to the client system for training of its own model. The model weights may be provided to individual client systems and/or to a group of client systems and/or to all client systems that may have provided representations of their client data to the centralized model. Upon receipt of the model weights, the client system(s) may execute training of their respective client models. The above process may be repeated as many times as necessary and/or on continuous basis to ensure that client models are up to date.

In some embodiments, the current subject matter may be configured to receive feedback from client system and/or any other computing devices. The feedback may be provided to the representations (e.g., client system generated representations, filtered representations, etc.), generated model weights, filtering parameters (coarse and/or fine), etc. Once feedback is received, the current subject matter may be configured to update one or more model weights, representations, filtering parameters, etc. Moreover, the feedback may then be used to train, retrain, refresh train, etc. the centralized model(s), one or more client systems' ML models, etc. As can be understood, the feedback may be used to perform any desired action and/or any combination of actions.

In some embodiments, the user may provide feedback (e.g., “thumbs up”, “thumbs down”, vote, written feedback, etc.). The feedback may be used to adjust and/or finetune, for example, how representations are generated, filtering is applied, model weights are generated, etc. For example, too many thumbs down on one or more model weights may indicate that the way the model weights are generated may need be adjusted to account for more important content, other documents, other portions, etc.

The current subject matter may have one or more of the following technical benefits. In particular, the use of the federated learning system allows training of client models without accessing client system's sensitive data, thereby preserving privacy of client data and complying with appropriate privacy data regulations, while ensuring proper training of client models. Generation of model weights in accordance with implementations of the current subject matter, and specifically, using filtering mechanisms, allows such weights to be free of noisy data, which is a common problem associated with existing solutions. Existing system generate such model weights randomly, which may lead to poor quality training of models, generation of inaccurate results, and/or any other errors. In contrast, the current subject matter generates model weights more precisely enabling proper training of client models as well as outputting of accurate analysis and results by the models in response to queries, tasks, etc.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application, or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct, or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

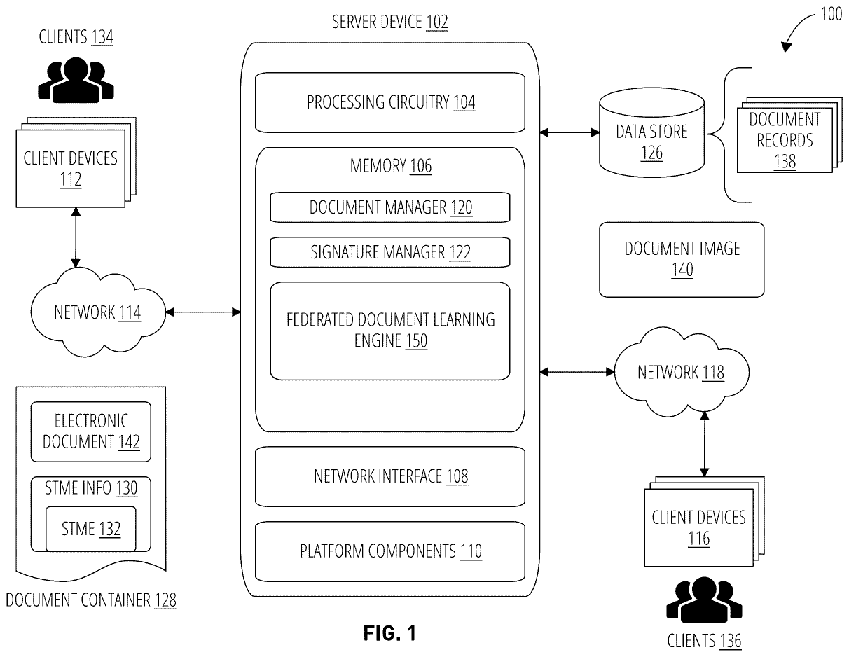

FIG. 1 illustrates an embodiment of a system 100. The system 100 may be suitable for implementing one or more embodiments as described herein. In one embodiment, for example, the system 100 may comprise an electronic document management platform (EDMP) suitable for managing a collection of electronic documents. An example of an EDMP includes a product or technology offered by DocuSign®, Inc., located in San Francisco, California (“DocuSign”). DocuSign is a company that provides electronic signature technology and digital transaction management services for facilitating electronic exchanges of contracts and signed documents. An example of a DocuSign product is a DocuSign Agreement Cloud that is a framework for generating, managing, signing and storing electronic documents on different devices. It may be appreciated that the system 100 may be implemented using other EDMP, technologies and products as well. For example, the system 100 may be implemented as an online signature system, online document creation and management system, an online workflow management system, a multi-party communication and interaction platform, a social networking system, a marketplace and financial transaction management system, a customer record management system, and other digital transaction management platforms. Embodiments are not limited in this context.

The system 100 may implement an EDMP as a cloud computing system. Cloud computing is a model for providing on-demand access to a shared pool of computing resources, such as servers, storage, applications, and services, over the Internet. Instead of maintaining their own physical servers and infrastructure, companies can rent or lease computing resources from a cloud service provider. In a cloud computing system, the computing resources are hosted in data centers, which are typically distributed across multiple geographic locations. These data centers are designed to provide high availability, scalability, and reliability, and are connected by a network infrastructure that allows users to access the resources they need. Some examples of cloud computing services include Infrastructure-as-a-Service (IaaS), Platform-as-a-Service (PaaS), and Software-as-a-Service (SaaS).

The system 100 may implement various search tools and algorithms designed to search for electronic document(s) and/or collections of electronic documents (which may also be referred to as “transaction documents”, “transaction packages”, “document packages” or “packages”) and/or information within an electronic document or across a collection of electronic documents. Within the context of a cloud computing system, the system 100 may implement a cloud search service accessible to users via a web interface or web portal front-end server system. A cloud search service is a managed service that allows developers and businesses to add search capabilities to their applications or websites without the need to build and maintain their own search infrastructure. Cloud search services typically provide powerful search capabilities, such as faceted search, full-text search, and auto-complete suggestions, while also offering features like scalability, availability, and reliability. A cloud search service typically operates in a distributed manner, with indexing and search nodes located across multiple data centers for high availability and faster query responses. These services typically offer application program interfaces (APIs) that allow developers to easily integrate search functionality into their applications or websites. One major advantage of cloud search services is that they are designed to handle large-scale data sets and provide powerful search capabilities that can be difficult to achieve with traditional search engines. Cloud search services can also provide advanced features, such as machine learning-powered search, natural language processing, and personalized recommendations, which can help improve the user experience and make search more efficient. Some examples of popular cloud search services include Amazon CloudSearch, Elasticsearch, and Azure Search. These services are typically offered on a pay-as-you-go basis, allowing businesses to pay only for the resources they use, making them an affordable option for businesses of all sizes.

In general, the system 100 may allow users to generate, revise and electronically sign electronic documents. When implemented as a large-scale cloud computing service, the system 100 may allow entities and organizations to amass a significant number of electronic documents, including both signed electronic documents and unsigned electronic documents. As such, the system 100 may need to manage a large collection of electronic documents for different entities, a task that is sometimes referred to as contract lifecycle management (CLM).

As shown in FIG. 1, the system 100 may include a server device 102 communicatively coupled to a set of client devices 112 via a network 114. The server device 102 may also be communicatively coupled to a set of client devices 116 via a network 118. The client devices 112 may be associated with a set of clients 134. The client devices 116 may be associated with a set of clients 136. In one network topology, the server device 102 may represent any server device, such as a server blade in a server rack as part of a cloud computing architecture, while the client devices 112 and the client devices 116 may represent any client device, such as a smart wearable (e.g., a smart watch), a smart phone, a tablet computer, a laptop computer, a desktop computer, a mobile device, and so forth. The server device 102 may be coupled to a local or remote data store 126 to store document records 138. It may be appreciated that the system 100 may have more or less devices than shown in FIG. 1 with a different network topology as needed for a given implementation. Embodiments are not limited in this context.

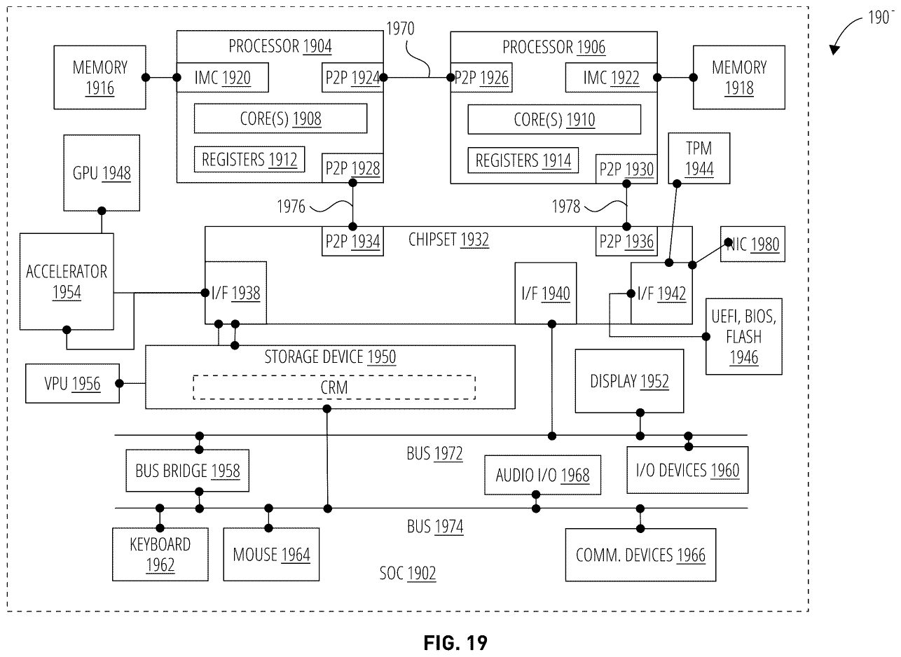

In various embodiments, the server device 102 may include various hardware elements, such as a processing circuitry 104, a memory 106, a network interface 108, and a set of platform components 110. The client devices 112 and/or the client devices 116 may include similar hardware elements as those depicted for the server device 102. The server device 102, client devices 112, and client devices 116, and associated hardware elements, are described in more detail with reference to a computing architecture 1900 as depicted in FIG. 19.

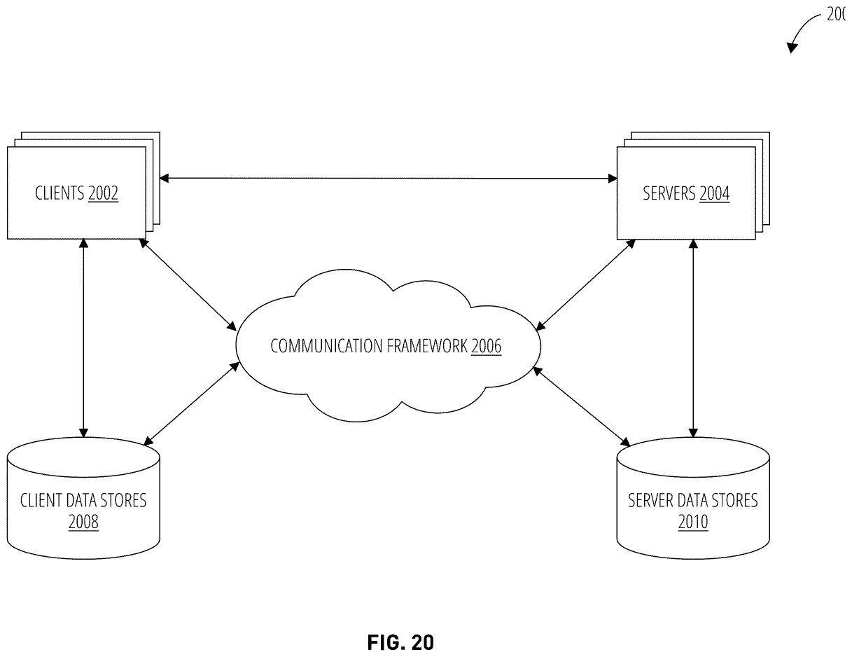

In various embodiments, the server devices 102, 112 and/or 116 may communicate various types of electronic information, including control, data and/or content information, via one or both network 114, network 118. The network 114 and the network 118, and associated hardware elements, are described in more detail with reference to a communications architecture 2000 as depicted in FIG. 20.

The memory 106 may store a set of software components, such as computer executable instructions, that when executed by the processing circuitry 104, causes the processing circuitry 104 to implement various operations for an electronic document management platform. As depicted in FIG. 1, for example, the memory 106 may include a document manager 120, a signature manager 122, and a sensitive data identification engine 150, among other software elements.

The document manager 120 may generally manage a collection of electronic documents stored as document records 138 in the data store 126. The document manager 120 may receive as input a document container 128 for an electronic document. A document container 128 is a file format that allows multiple data types to be embedded into a single file, sometimes referred to as a “wrapper” or “metafile.” The document container 128 can include, among other types of information, an electronic document 142 and metadata for the electronic document 142.

A document container 128 may include an electronic document 142. The electronic document 142 may comprise any electronic multimedia content intended to be used in an electronic form. The electronic document 142 may comprise an electronic file having any given file format. Examples of file formats may include, without limitation, Adobe portable document format (PDF), Microsoft Word, PowerPoint, Excel, text files (.txt, .rtf), and so forth. In one embodiment, for example, the electronic document 142 may comprise a PDF created from a Microsoft Word file with one or more workflows developed by Adobe Systems Incorporated, an American multi-national computer software company headquartered in San Jose, California. Embodiments are not limited to this example.

In addition to the electronic document 142, the document container 128 may also include metadata for the electronic document 142. In one embodiment, the metadata may comprise signature tag marker element (STME) information 132 for the electronic document 142. The STME information 130 may include one or more STME 132, which are graphical user interface (GUI) elements superimposed on the electronic document 142. The GUI elements may include textual elements, visual elements, auditory elements, tactile elements, and so forth. In some embodiments, for example, the STME information 130 and STME 132 may be implemented as text tags, such as DocuSign anchor text, Adobe® Acrobat Sign® text tags, and so forth. Text tags are specially formatted text that can be placed anywhere within the content of an electronic document specifying the location, size, type of fields such as signature and initial fields, checkboxes, radio buttons, and form fields; and advanced optional field processing rules. Text tags can also be used when creating PDFs with form fields. Text tags may be converted into signature form fields when the document is sent for signature or uploaded. Text tags can be placed in any document type such as PDF, Microsoft Word, PowerPoint, Excel, and text files (.txt, .rtf). Text tags offer a flexible mechanism for setting up document templates that allow positioning signature and initial fields, collecting data from multiple parties within an agreement, defining validation rules for the collected data, and adding qualifying conditions. Once a document is correctly set up with text tags it can be used as a template when sending documents for signatures ensuring that the data collected for agreements is consistent and valid throughout the organization.

In one embodiment, the STME 132 may be utilized for receiving signing information, such as GUI placeholders for approval, checkbox, date signed, signature, social security number, organizational title, and other custom tags in association with the GUI elements contained in the electronic document 142. A client 134 may have used the client device 112 and/or the server device 102 to position one or more signature tag markers over the electronic document 142 with tools applications, and workflows developed by DocuSign or Adobe. For instance, assume the electronic document 142 is a commercial lease associated with STME 132 designed for receiving signing information to memorialize an agreement between a landlord and tenant to lease a parcel of commercial property. In this example, the signing information may include a signature, title, date signed, and other GUI elements.

The document manager 120 may process a document container 128 to generate a document image 140. The document image 140 is a unified or standard file format for an electronic document used by a given EDMP implemented by the system 100. For instance, the system 100 may standardize use of a document image 140 having an Adobe portable document format (PDF), which is typically denoted by a “.pdf” file extension. If the electronic document 142 in the document container 128 is in a non-PDF format, such as a Microsoft Word “.doc” or “.docx” file format, the document manager 120 may convert or transform the file format for the electronic document into the PDF file format. Further, if the document container 128 includes an electronic document 142 stored in an electronic file having a PDF format suitable for rendering on a screen size typically associated with a larger form factor device, such as a monitor for a desktop computer, the document manager 120 may transform the electronic document 142 into a PDF format suitable for rendering on a screen size associated with a smaller form factor device, such as a touch screen for a smart phone. The document manager 120 may transform the electronic document 142 to ensure that it adheres to regulatory requirements for electronic signatures, such as a “what you see is what you sign” (WYSIWYS) property, for example.

The signature manager 122 may generally manage signing operations for an electronic document, such as the document image 140. The signature manager 122 may manage an electronic signature process to send the document image 140 to signers, obtaining electronic signatures, verifying electronic signatures, and recording and storing the electronically signed document image 140. For instance, the signature manager 122 may communicate a document image 140 over the network 118 to one or more client devices 116 for rendering the document image 140. A client 136 may electronically sign the document image 140 and send the signed document image 140 to the server device 102 for verification, recordation, and storage.

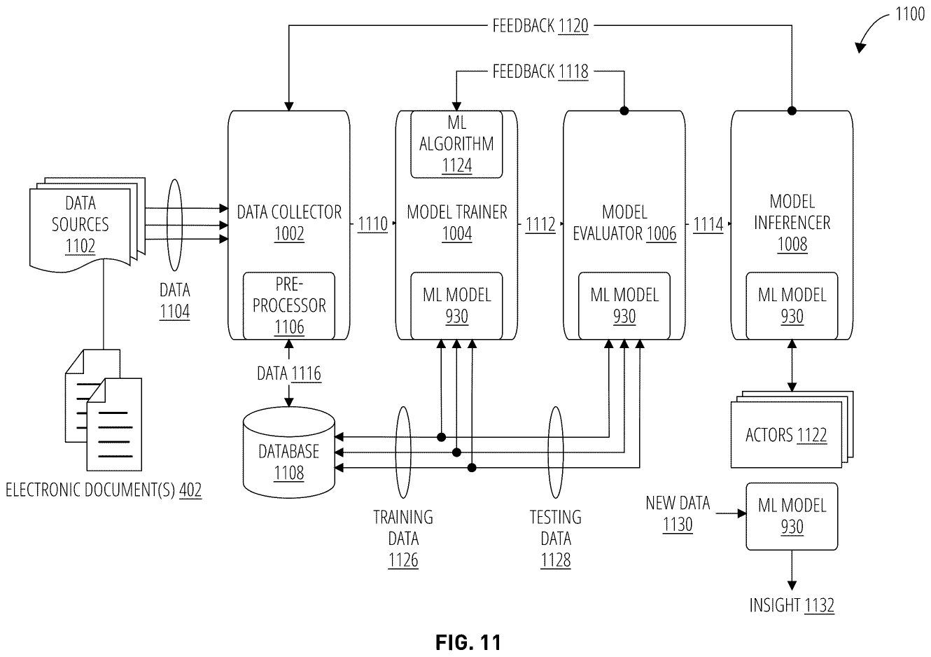

The federated document learning engine 150 may implement and/or manage various artificial intelligence (AI) and machine learning (ML) agents to assist in various operational tasks for the EDMP of the system 100. The AI/ML agents and their operation associated with the federated document learning engine 150, and associated software elements, are described in more detail with reference to an artificial intelligence architecture 1100 as depicted in FIG. 11. The engine 150, and associated hardware elements, are described in more detail with reference to a computing architecture 1900 as depicted in FIG. 19.

In general operation, assume the server device 102 receives a document container 128 from a client device 112 over the network 114. The server device 102 processes the document container 128 and makes any necessary modifications or transforms as previously described to generate the document image 140. The document image 140 may have a file format of an Adobe PDF denoted by a “.pdf” file extension. The server device 102 sends the document image 140 to a client device 116 over the network 118. The client device 116 renders the document image 140 with the STME 132 in preparation for electronic signing operations to sign the document image 140.

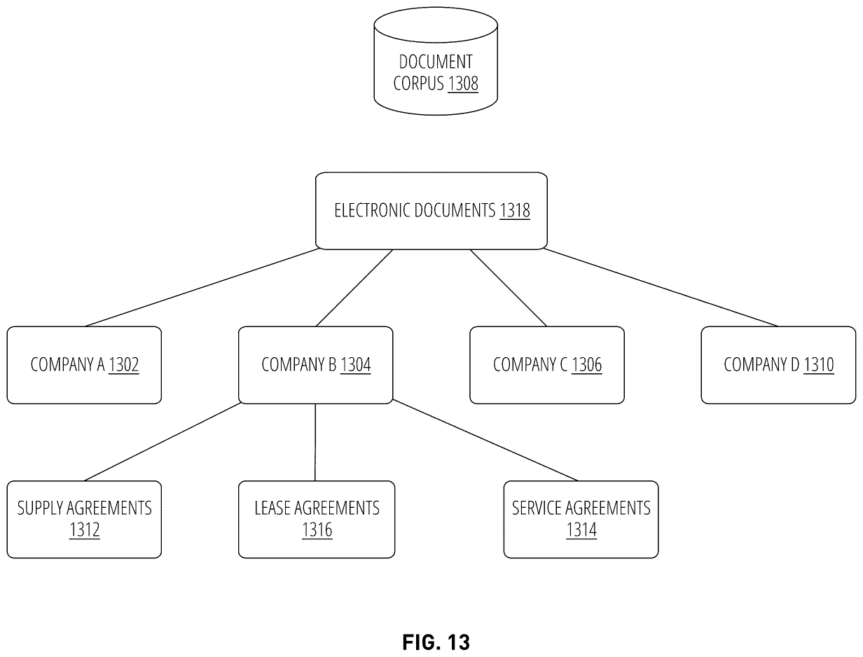

The document image 140 may further be associated with STME information 130 including one or more STME 132 that were positioned over the document image 140 by the client device 112 and/or the server device 102. The STME 132 may be utilized for receiving signing information (e.g., approval, checkbox, date signed, signature, social security number, organizational title, etc.) in association with the GUI elements contained in the document image 140. For instance, a client 134 may use the client device 112 and/or the server device 102 to position the STME 132 over the electronic documents 1318, as shown in FIG. 13, with tools, applications, and workflows developed by DocuSign. For example, the electronic documents 1318 may be a commercial lease that is associated with one or more or more STME 132 for receiving signing information to memorialize an agreement between a landlord and tenant to lease a parcel of commercial property. For example, the signing information may include a signature, title, date signed, and other GUI elements.

Broadly, a technological process for signing electronic documents may operate as follows. A client 134 may use a client device 112 to upload the document container 128, over the network 114, to the server device 102. The document manager 120, at the server device 102, receives and processes the document container 128. The document manager 120 may confirm or transform the electronic document 142 as a document image 140 that is rendered at a client device 116 to display the original PDF image including multiple and varied visual elements. The document manager 120 may generate the visual elements based on separate and distinct input including the STME information 130 and the STME 132 contained in the document container 128. In one embodiment, the PDF input in the form of the electronic document 142 may be received from and generated by one or more workflows developed by Adobe Systems Incorporated. The STME 132 input may be received from and generated by workflows developed by DocuSign. Accordingly, the PDF and the STME 132 are separate and distinct input as they are generated by different workflows provided by different providers.

The document manager 120 may generate the document image 140 for rendering visual elements in the form of text images, table images, STME images and other types of visual elements. The original PDF image information may be generated from the document container 128 including original documents elements included in the electronic document 142 of the document container 128 and the STME information 130 including the STME 132. Other visual elements for rendering images may include an illustration image, a graphic image, a header image, a footer image, a photograph image, and so forth.

The signature manager 122 may communicate the document image 140 over the network 118 to one or more client devices 116 for rendering the document image 140. The client devices 116 may be associated with clients 136, some of which may be signatories or signers targeted for electronically signing the document image 140 from the client 134 of the client device 112. The client device 112 may have utilized various workflows to identify the signers and associated network addresses (e.g., email address, short message service, multimedia message service, chat message, social message, etc.). For example, the client 134 may utilize workflows to identify multiple parties to the lease including bankers, landlord, and tenant. Further, the client 134 may utilize workflows to identify network addresses (e.g., email address) for each of the signers. The signature manager 122 may further be configured by the client 134 whether to communicate the document image 140 in series or parallel. For example, the signature manager 122 may utilize a workflow to configure communication of the document image 140 in series to obtain the signature of the first party before communicating the document image 140, including the signature of the first party, to a second party to obtain the signature of the second party before communicating the document image 140, including the signature of the first and second party to a third party, and so forth. Further for example, the client 134 may utilize workflows to configure communication of the document image 140 in parallel to multiple parties including the first party, second party, third party, and so forth, to obtain the signatures of each of the parties irrespective of any temporal order of their signatures.

The signature manager 122 may communicate the document image 140 to the one or more parties associated with the client devices 116 in a page format. Communicating in page format, by the signature manager 122, ensures that entire pages of the document image 140 are rendered on the client devices 116 throughout the signing process. The page format is utilized by the signature manager 122 to address potential legal requirements for binding a signer. The signature manager 122 utilizes the page format because a signer is only bound to a legal document that the signer is intended to be bound. To satisfy the legal requirement of intent, the signature manager 122 generates PDF image information for rendering the document image 140 to the one or more parties with a “what you see is what you sign” (WYSIWYS) property. The WYSIWYS property ensures the semantic interpretation of a digitally signed message is not changed, either by accident or by intent. If the WYSIWYS property is ignored, a digital signature may not be enforceable at law. The WYSIWYS property recognizes that, unlike a paper document, a digital document is not bound by its medium of presentation (e.g., layout, font, font size, etc.) and a medium of presentation may change the semantic interpretation of its content. Accordingly, the signature manager 122 anticipates a possible requirement to show intent in a legal proceeding by generating original PDF image information for rendering the document image 140 in page format. The signature manager 122 presents the document image 140 on a screen of a display device in the same way the signature manager 122 prints the document image 140 on the paper of a printing device.

As previously described, the document manager 120 may process a document container 128 to generate a document image 140 in a standard file format used by the system 100, such as an Adobe PDF, for example. Additionally, or alternatively, the document manager 120 may also implement processes and workflows to prepare an electronic document 142 stored in the document container 128. For instance, assume a client 134 uses the client device 112 to prepare an electronic document 142 suitable for receiving an electronic signature, such as the lease agreement in the previous example. The client 134 may use the client device 112 to locally or remotely access document management tools, features, processes and workflows provided by the document manager 120 of the server device 102. The client 134 may prepare the electronic document 142 as a brand new originally written document, a modification of a previous electronic document, or from a document template with predefined information content. Once prepared, the signature manager 122 may implement electronic signature (c-sign) tools, features, processes and workflows provided by the signature manager 122 of the server device 102 to facilitate electronic signing of the electronic document 142.

In addition, as discussed above, the system 100 may include a federated document learning engine 150. The federated document learning engine 150 may implement a set of tools and/or algorithms to perform federated learning of electronic documents. In some embodiments, the engine 150 may be configured to apply a machine learning model associated with the federated document learning engine 150 to a plurality of representations of client datasets stored by client systems and that contain data that client systems might not wish to expose outside of client systems. The representations may be generated by the client systems using a publicly available machine learning model that may be provided by the federated document learning engine 150 to each client system. The machine learning model of the engine 150 may generate a combined representation of a plurality of datasets based on the representations provided by the client systems. Client system's datasets are not provided to the engine 150's machine learning model. The engine 150 may then use the machine learning model to filter the combined representation using one or more filtering parameters to generate a filtered representation. Filtering may involve use of coarse filtering parameters (e.g., removal of elements in the combined representation that are not relevant to a specific document learning query (e.g., forms, etc.)), and then use of fine filtering parameters (e.g., removal of elements in the combined representation that may be irrelevant to the specific document learning query (e.g., remove all data elements in the combined representation that are not relevant to sales agreements)). Once the filtration is completed, the machine learning model may generate one or more model weights for training client machine learning models. Each client machine learning model is associated with a respective client system. Each representation in the plurality of representations identifies one or more features of data in the respective dataset in the plurality of datasets. One or more features of the dataset includes at least one of the following: a type of data, a subtype of data, one or more identifiers of data, a metadata, and any combination thereof.

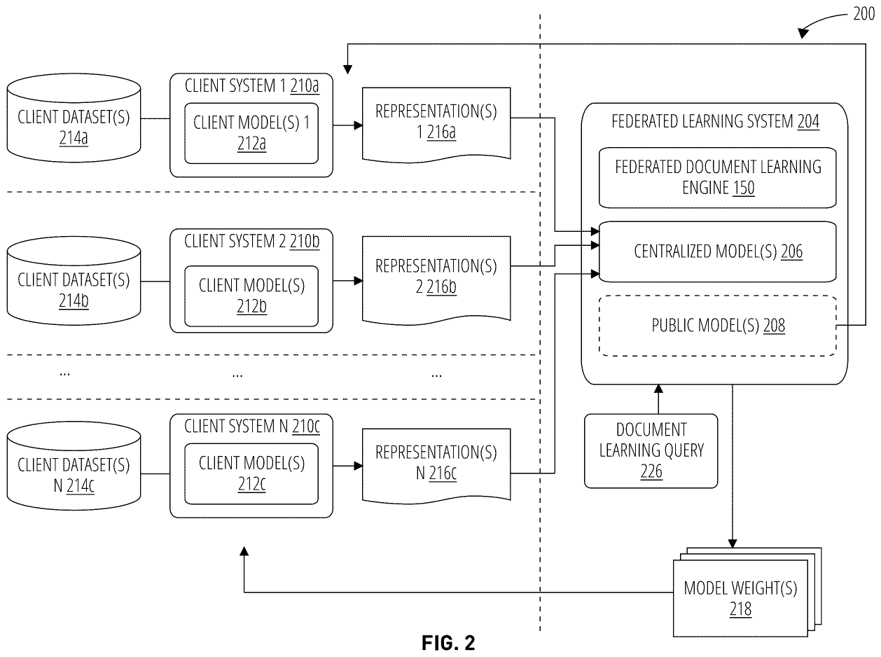

FIG. 2 illustrates an example computing system 200 that may be used for federated document learning, according to some embodiments of the current subject matter. The system 200 may include one or more client systems 210 and federated learning system 204. The client systems 210 and the federated learning system 204 may be communicatively coupled using one or more communication networks. Each client system 210 and the federated learning system 204 may be separated from one another (as shown by dashed lines) to prevent sharing of client-specific data (whether deliberate or inadvertent).

The federated learning system 204 may include the federated document learning engine 150, one or more centralized model(s) 206, and public model(s) 208. The public model(s) 208 may be part of the federated learning system 204 and/or may be stored in a separate storage location. The public model(s) 208 may be any type of model that may be publicly available.

Each client system 210 may include one or more respective client models 212 and may include and/or be communicatively coupled to a respective storage locations that may store its client datasets 214. For example, the client system 1 210a may include its client model(s) 1 212a and client dataset(s) 214a. The client system 1 210a may be separated from other client system 2 210b, . . . , client system n 210c, where client system 1 210a, client system 2 210b, . . . client system n 210c do not share data in their respective client dataset(s) 214a, client dataset(s) 214b, . . . , client dataset(s) n 214c.

Client models 212 may be machine learning models that each respective client system 210 may use to execute various processes related to analysis of data stored in the respective client datasets 214. For example, client model(s) 1 212a of the client system 1 210a may be used to respond to a query related to the client dataset(s) 214a. The query may, for instance, state “summarize all sales agreements that are stored in the client dataset(s)”. In response to this query, the client model(s) 1 212a may be used to access client dataset(s) 214a, analyze data stored in client dataset(s) 214a, retrieve responsive data and perform summarization of such data for presentation. As can be understood, the models 210 may be used to perform any other tasks.

Each client system 210 may be configured to train its respective models 212. Training may be performed using any desired methodologies, such as, for example training datasets, historical documents, etc. To preserve privacy of its datasets 214, each client system 210 may train its models using its own training datasets. To ensure that each client model 212 is properly trained and thus, correctly performs tasks that it is being asked, the current subject matter may be configured to generate and provide one or more model weight(s) 218. The model weight(s) 218 may be generated without accessing the data contained in the client datasets 214.

To generate model weight(s) 218, the federated learning system 204 may be configured to receive one or more document learning query and/or task 226. The document learning query 226 may, for example, identify specific type of processing that the client systems 210 would like its client models 212 to do. For instance, the client system 1 210a would like its client model(s) 1 212a to perform summarization of all sales agreements stored in client dataset(s) 214a; client system 2 210b would like its client model(s) 212b to determine revenue from all lease agreements stored in client dataset(s) 214b; etc. A single or multiple document learning queries 226 may be received by the federated learning system 204. The system 204 may analyze queries 226 to determine whether each needs to be processed separately to generate appropriate model weight(s) 218 and/or whether some and/or all may be processed together. The document learning query 226 may identify specific type of data, subtype of data, subject matter, and/or any other data that each client system 210 may be looking for its respective client models 212 to process. In response to the queries, the federated learning system 204 may generate individual model weight(s) 218 and provide them to specific client systems 210 and/or general model weight(s) 218 and provide them to all or some client systems 210.

For generation of model weight(s) 218, the system 204 may be configured to provide public model(s) 208 to each client system 210 and request it to generate one or more respective representations of the data stored in its respective client dataset(s) 214. The public model(s) 208 may be publicly available machine learning models that may be designed to generate one or more structural representations of data. For example, public model(s) 208 may be used to generate a hierarchical representation of data, a catalog of data that may be organized by topic (e.g., sales agreements, lease agreements, etc.), a list of data, and/or other representation(s). In some embodiments, each public model(s) 208 may generate specific type of representation. In providing the public model(s) 208 to the client systems 210, the federated learning system 204 may specifically request that representations are generated in a particular way, e.g., only hierarchical representations, only catalog representations, etc. Alternatively, or in addition, the representations may be generated in any desired way. The federated learning system 204 may be configured to process representations of different types.

Once the public model(s) 208 is provided to the client systems 210, each client system may be configured to apply the public model(s) 208 to their respective client datasets 214 to generate corresponding representations. For instance, client system 1 210a may be configured to apply public model(s) 208 to its client dataset(s) 214a and generate a representation(s) 1 216a of its data (which may be a hierarchical representation); client system 2 210b may be configured to apply public model(s) 208 to its client dataset(s) 214b and generate a representation(s) 2 216b of its data (which may be a catalog representation); . . . client system n 210c may be configured to apply public model(s) 208 to its client dataset(s) n 214c and generate a representation(s) n 216c of its data (which may be a list representation). Because client systems 210 are separate from one another, the representations are limited to the respective client datasets 214 and do not include representations of any other client datasets. As stated above, the representations 216 may have the same and/or different types. Each representation 216 may also be associated with respective metadata, which may include, for example, various identifiers (e.g., identifying type of data without revealing what the data is, structural position in the representation, location in the client dataset, etc.), descriptors (which may be appropriately anonymized), and/or any other information. The metadata may be used by the federated learning system 204 during generation of model weight(s) 218. Alternatively, or in addition, the federated learning system 204 may, in addition to and/or instead of using a public model 208, generate representations using at least one of: one or more previous learning and/or training tasks (e.g., prior learning queries, etc. (which may be the same and/or different as a current learning query)), client system's models, and/or generated in any other way based on the client datasets.

In some embodiments, the representation(s) 216 may be configured to identify types of data, subtypes of data, and/or any other features of information/data that may be stored in the client dataset(s) 214. For instance, the representation(s) may indicate that the data contained in the client dataset(s) has a legal agreement type and a subtype-sales agreement. Moreover, it may indicate that the sales agreement includes one or more of the following features: parties names, parties addresses, etc. It may also indicate features that might not be related to the content of the agreement, e.g., where the sales agreement may be stored in the client dataset(s) storage location. As can be understood, any other information may be contained in the representation(s).

The generated representations 216 may be provided to the federated learning system 204, and in particular, to the centralized model(s) 206 for further processing. The centralized model(s) 206 may be configured to combine all received representations 216, e.g., to generate a combined representation, and applying one or more filtering parameters, in accordance with document learning query 226, to remove and/or filter out various data/information that may be considered irrelevant and/or noisy. For example, in the representation(s) of client datasets, the filtering processes performed by the centralized model(s) 206 may remove various forms that might not be relevant to the sales agreement representation(s) (as defined by the document learning query 226). In some embodiments, the filtering may be defined by specific client policies, requirements, preferences, etc., which may be provided to the centralized model(s) 206 along with representation(s) and/or as a separate request. These may likewise be defined by the document learning query 226.

Once the initial filtering is performed, the federated learning system 204 may be configured to execute dynamic filtering to identify specific elements in the representation(s) that may be more important than others and, hence, may be used for generation of model weight(s) 218. The filtering parameters for the dynamic filtering may likewise be defined by the document learning query 226. The importance of elements may be defined by the client systems and/or determined by the federated learning system 204 based on the received representation(s). For instance, the client systems may indicate that sales agreements with particular types of parties (e.g., large corporations) may be more important than with other types of parties (e.g., small corporations). Thus, the centralized model(s) 206 may filter out elements that are less important (e.g., elements related to small corporation sales agreements) and keep elements related to important items. Alternatively, or in addition, the centralized model(s) 206 may be configured to generate greater model weight(s) 218 for elements that are important and smaller model weight(s) 218 for elements that are less important. This may allow retention of all elements rather than discarding some entirely. During training by the client systems of their respective client models, elements with greater model weights will ensure that the trained models give greater preference to corresponding data points in the client dataset(s).

In some embodiments, the centralized model(s) 206 may be configured determine, in accordance with the document learning query 226, which elements in the representation(s) should be accorded a greater weight. This may, for example, be determined based on a frequency of elements having a specific type appearing in the representation(s). For instance, elements identifying large corporations in sales agreements may be more frequent in the representation(s) than elements identifying small corporations in such agreements. Hence, using this information, the centralized model(s) 206 may be configured to determine that the first elements should be given greater model weight(s) 218 than the second elements. Alternatively, or in addition, the second elements may be filtered out in their entirety. As can be understood, any factors may be used to determine which elements should be accorded greater model weights for the purposes of training client model(s).

Upon completion of the filtering process, the centralized model(s) 206 may be configured to generate model weight(s) 218. The model weight(s) 218 may be specific to a particular client system and/or systems, and/or may be applicable to all client systems. The model weight(s) 218 may have been generated based on a particular representation(s) and/or based on all representation(s) that have been received by the federated learning system 204. Further, the model weight(s) 218 may be generated for a particular type of client model(s) (e.g., a model that labels sales agreements with large corporations) and/or client dataset(s) (e.g., a dataset that includes lease agreements with commercial tenants) to which client model(s) may be applied to for the purposes of analysis, data extraction, etc. The federated learning system 204 may provide the generated model weight(s) 218 to the client systems 210. The client systems 210 may use the model weight(s) 218 to train their respective client model(s) 212. As no data from client dataset(s) is shared among client systems 210 and/or with federated learning system 204, the client dataset(s) remain within respective client systems 210's possession at all times.

In some embodiments, the above federated learning process may continue and/or may be repeated as many time as desired. This may ensure that updates to client dataset(s) are accounted for, and the client model(s) are trained on the latest model weight(s) 218 that are generated based the latest versions of data in the client dataset(s).

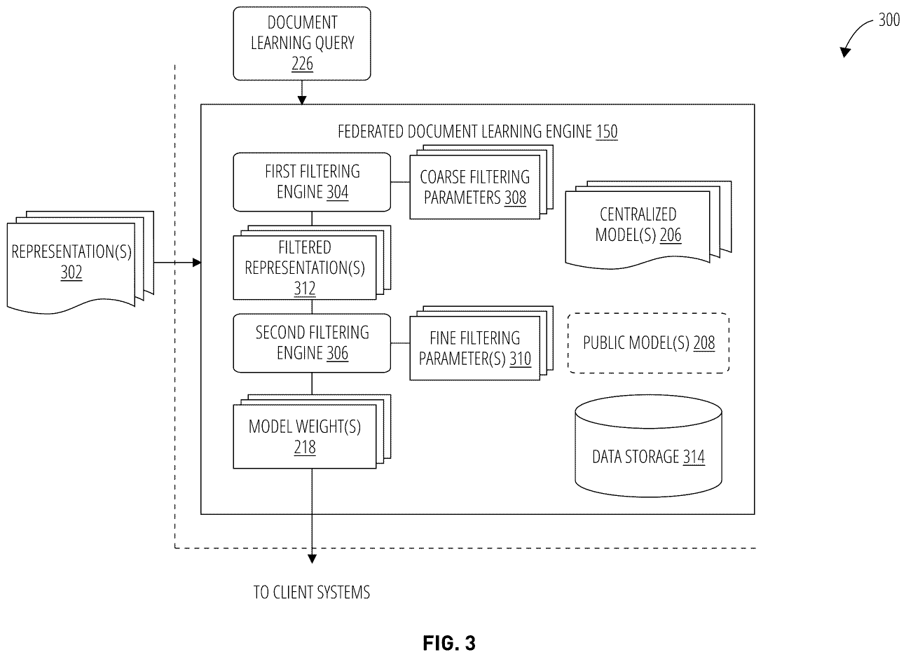

FIG. 3 illustrates an example system 300 showing operation of the federated document learning engine 150, according to some embodiments of the current subject matter. The federated document learning engine 150 may include a first filtering engine 304 and a second filtering engine 306. The federated document learning engine 150 may also implement one or more centralized model(s) 206 and/or public model(s) 208. In some embodiments, one or more representation(s) 302 (similar to representation(s) 216 shown in FIG. 2) may be received by the engine 150 for analysis and generation of one or more model weight(s) 218. To generate model weight(s) 218, the federated document learning engine 150 may be configured to use one or more of the coarse filtering parameters 308 and/or fine filtering parameter(s) 310, where coarse filtering parameters 308 may be used by the first filtering engine 304 and the fine filtering parameter(s) 310 may be used by the second filtering engine 306.

The federated document learning engine 150 may be configured to store the representation(s) 302, coarse filtering parameters 308, fine filtering parameter(s) 310, and/or model weight(s) 218 along with any relevant data/information in the data storage 314. The data storage 314 may also store various metadata associated with the representation(s) 302, coarse filtering parameters 308, fine filtering parameter(s) 310, and/or model weight(s) 218 and/or any other data and/or information.

One or more components of the system 300 shown in FIG. 3 may be communicatively coupled using one or more communications networks. The communications networks may include one or more of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Further, one or more components of the system 300 may include any combination of hardware and/or software. In some embodiments, one or more components of the system may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example embodiments, one or more components of the system may be disposed on a single computing device and/or may be part of a single communications network. Alternatively, or in addition to, such devices may be separately located from one another. A device may be a computing processor, a memory, a software functionality, a routine, a procedure, a call, and/or any combination thereof that may be configured to execute a particular function associated with interface and/or document certification processes disclosed herein.

In some embodiments, one or more components of the system 300 may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 300 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the interface and/or document certification functions described herein. One or more components of the system may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some example embodiments, one or more components of the system 300 may execute one or more applications, such as software applications, that enable, for example, network communications with one or more components of system and transmit and/or receive data.

One or more components of the system 300 may include and/or be in communication with one or more servers via one or more networks and may operate as a respective front-end to back-end pair with one or more servers. One or more components of the system may transmit, for example from a mobile device application (e.g., executing on one or more user devices, components, etc.), one or more requests to one or more servers. The requests may be associated with retrieving data from servers (e.g., retrieving one or more representation(s) 302). The servers may receive the requests from the components of the system. Based on the requests, servers may be configured to retrieve the requested data from one or more storage locations. Based on receipt of the requested data from the databases, the servers may be configured to transmit the received data to one or more components of the system, where the received data may be responsive to one or more requests.

The system 300 may include one or more networks, such as, for example, networks that may be communicatively coupling the engine 150, the document storage source (e.g., storing representation(s) 302), and/or any other computing components. In some embodiments, networks may be one or more of a wireless network, a wired network or any combination of wireless network and wired network and may be configured to connect the components of the system and/or the components of the system to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The system 300 may include one or more servers, which may include one or more processors that may be coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system.

Further, one or more components of the system 300 may be configured to execute one or more actions using one or more containers. In some embodiments, each action may be executed using its own container. A container may refer to a standard unit of software that may be configured to include the code that may be needed to execute the action along with all its dependencies. This may allow execution of actions to run quickly and reliably.

As discussed above, the federated document learning engine 150 may be configured to receive the document learning query 226, which may define how representation(s) 302 (similar to the representations 216 shown in FIG. 2) may be filtered. The document learning query 226 may define one or more coarse filtering parameters 308 and one or more fine filtering parameter(s) 310. For instance, the document learning query 226 may indicate that client systems (as shown in FIG. 2) may be looking for specific tasks that they would like their client models to perform with respect to data stored in their respective datasets. These may include electronic document summarizations, mapping, analysis, evaluation, labeling, etc. To perform such tasks, the client models may need to be properly trained. Training of such models may be defined by one or more model weight(s) 218 that the federated document learning engine 150 may generate in response to the document learning query 226. The coarse filtering parameters 308 may be used to remove nodes and/or elements from representation(s) 302 that are entirely irrelevant to the document learning query 226 and the fine filtering parameter(s) 310 may be used to remove nodes and/or elements from the representation(s) 302 (once it has been pruned using coarse filtering parameters 308) that less important than others (e.g., elements in the representation(s) 302 related to sales agreement may be more important that elements in the representation(s) 302 related to lease agreements).

The received representation(s) 302 may include various nodes or elements that may indicate what data may be included in the client datasets without revealing what that data is. The client datasets may be one or more private databases, access to which might not be publicly available (e.g., internal company databases, specific user access databases, etc.). The databases may be organized in a predetermined fashion, which may allow case of access by client systems and their respective models to the electronic documents and/or any portions thereof. For example, data (e.g., electronic documents, etc.) stored in these databases may be labeled, searchable, and/or otherwise, easily identifiable. The data may be stored in a particular electronic format (e.g., PDF, .docx, etc.). The data may be structured and/or unstructured.

The datasets may also be and/or linked to public non-government databases, government databases (e.g., SEC-EDGAR, etc.), etc. that may store various electronic documents, such as, for example, legal documents (e.g., commercial contracts, lease agreements, public disclosures (e.g., 10 k statements, 5 k statements, quarterly reports, etc.)), non-legal documents (e.g., articles, books, etc.). The data stored in these databases may be identified using various identifiers, which may allow location of the data in the databases, however, contents of electronic documents stored therein might not be parsed and/or specifically identified. For example, a review of an entire electronic document (e.g., 10k statement of a company stored in SEC-EDGAR database) may need to be performed to identify a particular section (e.g., a section related to compensation of executives for the company).

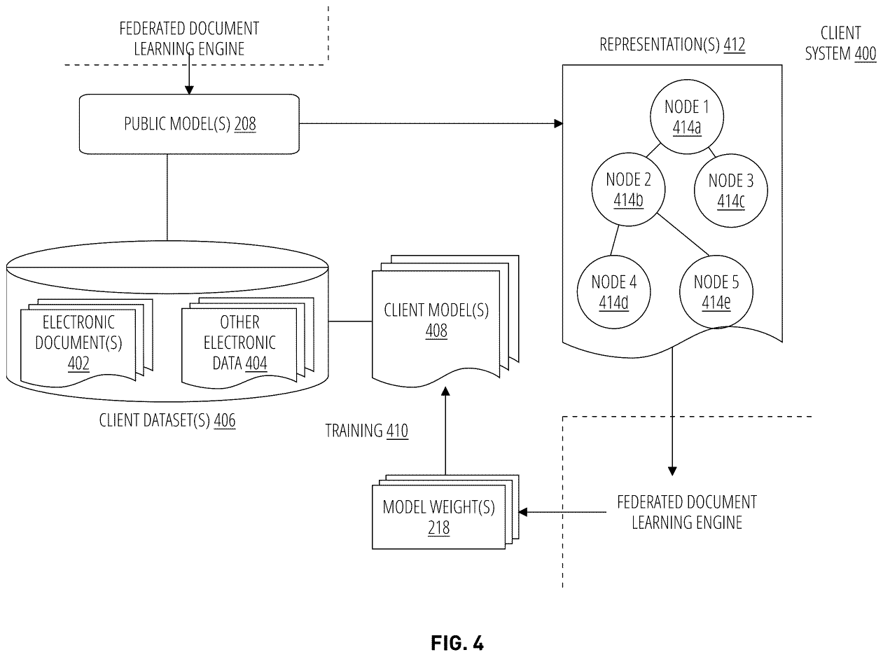

As stated above, the data in client datasets may be one or more electronic document(s) 402 and/or other electronic data 404 (as shown in FIG. 4). The electronic document(s) 402 and/or other electronic data 404 may be any type of documents, such as, for example, agreements, applications, websites, video files, audio files, text files, images, graphics, tables, spreadsheets, computer programs, etc. These may be in any desired format, e.g., .pdf, .docx, .xls, and/or any other type of format. They may also have any desired size. Moreover, the electronic document(s) 402 and/or other electronic data 404 may be organized in any desired fashion. In some examples, documents/data 402, 404 may be nested within other documents, data (e.g., one document embedded in another document); one document may be linked to another document, etc.

In some embodiments, electronic document(s) 402 and/or other electronic data 404 may include pages, headings, sub-headings, sections, paragraphs, sentences, tables, images, parties, conditions, terms, specific descriptions, and/or any other type of portions. One or more portions may also be associated and/or assigned one or more functions (e.g., a document title, a text heading, a text paragraph, etc.). The documents/data 402, 404 may be structured in a particular way (e.g., a lease agreement may include a section identifying parties, a section identifying leased premises, a section describing rent being paid, etc.). The electronic document(s) 402 and/or other electronic data 404 may also be unstructured.

The electronic document(s) 402 and/or other electronic data 404 may include various sensitive data, for instance, trade secrets (e.g., a soft drink formula, a manufacturing process involving a trade secret formula, etc.), commercially sensitive information (e.g., confidential sales data, confidential losses data, etc.), personally identification information (PII) (e.g., name(s), address(es), etc. of individuals, parties, etc.), medical information (e.g., medical conditions, diagnoses, etc.), and/or any other secret, confidential, nonpublic, etc. data, disclosure of which may be prohibited, detrimental to various parties, etc.

In generating representation(s) 302, the client models 212 may be configured to perform search of document portions/documents may be stored in respective client datasets 214 and that may be determined based on a search of the document's contents (e.g., text, images, graphics, etc.) and a determination of a presence of related terms, words, sentences, paragraphs, etc. in both, thereby making them related. For instance, the data stored in the datasets may include data that may indicate that the sales agreement data may be associated with and/or related to sales agreement data in other types of agreements (e.g., master services agreements, licenses, non-disclosure agreements, etc.). Such data may again be determined based on a search of datasets to identify data that may include semantically similar language. Moreover, the client datasets may store information related to any other data. For example, in the sales agreement, such data may include information about not only customer lists, but also parties to any sales agreements resulting in generation of the sales data, confidential information about terms of the sales agreements, and/or any other information.

Referring back to FIG. 3, the federated document learning engine 150 may be configured to receive the representation(s) 302 and use one or more centralized model(s) 206 generate a combined representation that may then be processed by the first filtering engine 304. The combined representation may be a combination of all representation(s) 302 that may be received from a single client system 210 and/or multiple client systems 210. For instance, the combined representation may group all representation(s) 302 by a particular subject matter (e.g., representations of all sales agreements from all client systems). Alternatively, or in addition, the combined representation may group all representation(s) 302 of any type of legal agreements. Further, the combined representation may group representations by client systems. As can be understood, the representation(s) 302 and/or their combinations may be formed and/or grouped in any desired way.

In some embodiments, the centralized model(s) 206 may be configured to arrange elements and/or nodes in the combined representation in any desired way. For example, it may use information in the document learning query 226, which may be related to sales agreements, to arrange nodes/elements in the specific hierarchical arrangement, where an element corresponding to a heading of a sales agreement may be positioned at the top of a hierarchy with other elements corresponding to sections and subsections linked to it in a predetermined fashion. Alternatively, or in addition, the elements or nodes in the combined representation may be arranged in a form of a catalog.

The combined representation may then be processed by the first filtering engine 304 of the federated document learning engine 150. The first filtering engine 304 may use one or more coarse filtering parameters 308 to filter the combined representation to remove node or elements of the representation that are entirely irrelevant to the document learning query 226. The coarse filtering parameters 308 may be generated by the federated document learning engine 150 (e.g., centralized model(s) 206) and may relate to a type of data that should be filtered (either removed or kept) that may be defined by the document learning query 226. The type of data may be legal agreements, non-legal agreements, etc. For example, the document learning query 226 may be related to analysis of sales agreements, and thus, any documents or data related to non-legal documents may be removed as irrelevant. Once filtered, the first filtering engine 304 may be configured to generate one or more filtered representation(s) 312. In some embodiments, the first filtering engine 304 may use one or more centralized model(s) 206 to perform filtering of the combined representation to generate filtered representation(s) 312. The centralized model(s) 206 may be specifically trained by the federated document learning engine 150 for the purposes of using the coarse filtering parameters 308 to generate filtered representation(s) 312.

The filtered representation(s) 312 may then be processed by the second filtering engine 306. The second filtering engine 306 may use fine filtering parameter(s) 310 to perform finer filtering of the combined representation. The second filtering engine 306 may likewise use centralized model(s) 206 to perform filtering. The fine filtering parameter(s) 310 may also be generated by the federated document learning engine 150 (e.g., centralized model(s) 206) based on the document learning query 226 and may be specific to a particular subject matter of the data. For example, the document learning query 226 may be related to analysis of sales agreements and in particular agreements with large corporations, and thus, any sales agreements with small corporations should be filtered out.

Upon completion of coarse and fine filtering, the federated document learning engine 150, using centralized model(s) 206, may be configured to generate one or more model weight(s) 218. The model weight(s) 218 may be indicative of specific weights that the client systems may use in training their respective client models. In the sales agreement example, higher weights may be assigned to features associated with sales agreements with large corporations, while lower weights may be assigned to features associated with sales agreements with small corporations and even smaller weights may be assigned to features in other documents. The federated document learning engine 150 may then provide the model weight(s) 218 to client systems. The client systems may receive the model weight(s) 218 and perform training of their respective client models. This process may continue to fine tune the weights and ensure that client models are adequately trained. The process may be continuous to accommodate for new data in client datasets (e.g., new agreements, etc.). As discussed above, one of the benefits of the generating model weights in this manner is that it allows the federated document learning engine 150 to generate accurate model weights for training of client system's models without client systems sharing any data with the engine 150.

In some embodiments, the representation(s) 302 and/or any of its combined representations, as well as coarse filtering parameters 308, fine filtering parameter(s) 310, filtered representation(s) 312, model weight(s) 218, and/or document learning query 226 may be stored in data storage 314. This may allow the federated document learning engine 150 to retrieve data from data storage 314 when necessary for processing of further document learning queries 226.

In some embodiments, the centralized model(s) 206 (and/or public model(s) 208) may be trained using data stored in the data storage 314, and/or any other data. As stated above, the data storage 314 may store any data that resulted from executions of processes by the federated document learning engine 150. The centralized model(s) 206 and/or public model(s) 208 may be part of the engine 150 and/or be one or more third party models, including, but not limited to, any artificial intelligence generative models, e.g., ChatGPT, Bard, DALL-E, Midjourney, DeepMind, etc., and may be accessed by the federated document learning engine 150, including its first filtering engine 304 and/or second filtering engine 306. In some embodiments, the data for training centralized model(s) 206 and/or public model(s) 208 may include any data resulting from previous operations by the engine 150.

In some embodiments, a user (e.g., a user of a client system) may provide feedback to the federated document learning engine 150. The feedback may also be in response to generated representation(s) 302, model weight(s) 218, etc. The feedback may be any type of feedback, such as, for example, a yes/no vote (e.g., thumbs up, thumbs down, etc.) that may be indicative of acceptance of and/or satisfaction with generated representation(s) 302, model weight(s) 218, etc. The feedback may be textual feedback that may include specific comments that may be written and sent to the federated document learning engine 150. As can be understood, any other type of feedback may be provided.

The federated document learning engine 150 may receive the user's feedback (whether positive or negative or neutral) and use it for various purposes. For example, the federated document learning engine 150 may update generated representation(s) 302, model weight(s) 218, etc. The federated document learning engine 150 may also identify centralized model(s) 206, public model(s) 208, etc. for the purposes of generating representation(s) 302, model weight(s) 218, etc. Further, the federated document learning engine 150 may use the user's feedback to update the centralized model(s) 206 and/or public model(s) 208. As can be understood, any other actions may be performed by the federated document learning engine 150 based on the user feedback. For example, the federated document learning engine 150 may train, re-train, refresh-train and/or create new centralized model(s) 206 and/or public model(s) 208. Feedback may be used to update any of the above operations and/or how any of them are performed. This process may continue until the user has no further feedback.

FIG. 4 illustrates an example client system 400 that may be used to generate one or more representation(s) 412, according to some embodiments of the current subject matter. The client system 400 may be similar to the client systems 210 shown in FIG. 2. The client system 400 may be communicatively coupled to federated document learning engine 150 but may be located behind a firewall and/or any other protective system that prevents client system 400 from sharing any of its data with federated document learning engine 150 (as shown by dashed lines in FIG. 4).

The client system 400 may be configured to include one or more client dataset(s) 406 (similar to client dataset(s) 214 shown in FIG. 2). The client dataset(s) 406 may, for example, include electronic document(s) 402 and/or other electronic data 404. As discussed above, the electronic document(s) 402 and/or other electronic data 404 may be legal documents (e.g., sales agreements, lease agreements, NDAs, etc.), non-legal documents (e.g., charts, tables, books, articles, publications, etc.), and/or any other type of data. The client system 400 may also include one or more client model(s) 408 (similar to client model(s) 212 shown in FIG. 2). The system 400 may use client model(s) 408 to processing of various queries on the client dataset(s) 406 (e.g., summarization of sales agreements stored in client dataset(s) 406).

The federated document learning engine 150 may be configured to provide the client system 400 with public model(s) 208 for generation of one or more representation(s) 412. As discussed herein, the engine 150 may provide the public model(s) 208 in response to a document learning query 226 (as shown in FIG. 3). The document learning query 226 may be received from the client system 400, another client system, and/or in any other way. The document learning query 226 may identify specific type of data, subject matter, and/or any other information, for which the client system 400 (and/or any other client system) may need model weight(s) 218 to train its client model(s) 408. For instance, the client system 400 may need model weight(s) 218 to train its client model(s) 408 to identify sales agreements with large corporations resulting in one million dollars in annual revenue.

Once the public model(s) 208 is received, the client system 400 may use the public model(s) 208 to generate one or more representation(s) 412 of the client dataset(s) 406. As shown in FIG. 4, the representation(s) 412 may be in a form a hierarchical structure having multiple elements or nodes 414. For example, in the sale agreement example, node 1 414a may correspond to a type of legal agreement; node 2 414b may correspond to a sales agreement; node 3 414c may correspond to a lease agreement; node 4 414d may correspond to a sales agreement with a large corporation; and node 5 414c may correspond to a sales agreement with a small corporation. The nodes 414 may be linked based on type of data and/or relevancy of data. As can be understood, the nodes may be arranged in any desired fashion and may correspond to any desired information (e.g., a list, a catalog, etc.) and/or data stored in client dataset(s) 406. Alternatively, or in addition, the federated learning system 204 may, in addition to and/or instead of using a public model, generate representation(s) 412 using at least one of: one or more previous learning and/or training tasks (e.g., prior learning queries, etc. (which may be the same and/or different as a current learning query)), client system's models, and/or generated in any other way based on the client datasets.

The representation(s) 412 may then be provided to the federated document learning engine 150 for generation of model weight(s) 218. Upon generating the model weight(s) 218, the engine 150 may be configured to provide them to the client system 400. The system 400 may then use the model weight(s) 218 to perform training 410 of its client model(s) 408. Once trained, the client system 400 may use client model(s) 408 to perform analysis of client dataset(s) 406 (e.g., by generating queries, prompts, etc. to the client model(s) 408 (e.g., “Find me sales agreements with large corporations resulting in one million dollars in annual revenue.”).

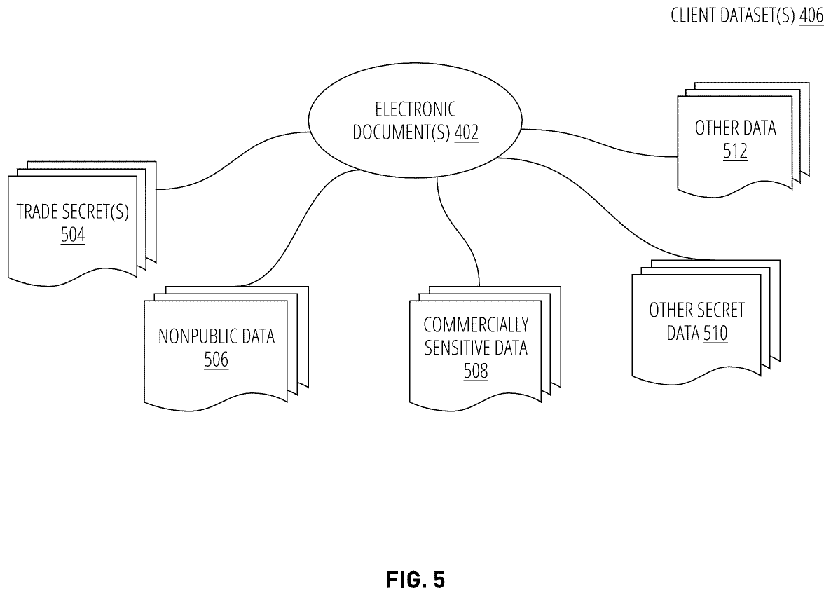

FIG. 5 illustrates an example client dataset(s) 406, according to some embodiments of the current subject matter. The object models stored in the client dataset(s) 406 may include various data (e.g., from electronic document(s) 402, other electronic data 404), which may include, for example, trade secret(s) 504, nonpublic data 506, commercially sensitive data 508, other secret data 510, and/or other data 512, and/or any other data, and/or any combination thereof. The data contained in any of these may include any of type of data, metadata, identifiers, etc.

The data 504-512 may include any other data, e.g., information about parties to agreements, description of products being sold, sales revenues, lease agreements, identification of trade secrets, and/or any other information. This data may be used for generation of one or more of representation(s) 412 by the client system 400 and/or for any other purpose.

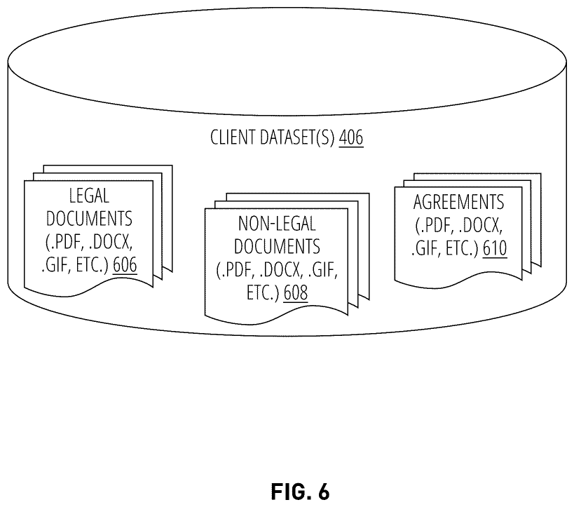

FIG. 6 illustrates an example of client dataset(s) 406, according to some embodiments of the current subject matter. The client dataset(s) 406 may be stored in a single database, repository, etc. and/or multiple databases, repositories, etc. The client dataset(s) 406 may be configured to be include any type of documents, data, information, files, etc.

The documents may be any type of documents, such as, for example, agreements, applications, websites, video files, audio files, text files, images, graphics, tables, spreadsheets, computer programs, etc. For example, as shown in FIG. 6, the client dataset(s) 406 may store one or more legal documents 606, non-legal documents 608, and/or agreements 610. Any of the documents 606, 608, and/or 610 may be in any desired format, e.g., .pdf, .docx, .xls, and/or any other type of format. The documents may also have any desired size. Moreover, the documents may be organized in any desired fashion. In some examples, documents may be nested within other documents (e.g., one document embedded in another document); one document may be linked to another document, etc. As such, the client dataset(s) 406 may be a unified data storage location that may store any type, any size, any format, etc. documents, data, information, etc.

In some embodiments, the documents stored in the client dataset(s) 406 may be structured, unstructured, and/or semi-structured. Moreover, the documents may be labeled and/or unlabeled. For example, one or more documents stored in the client dataset(s) 406 may have been processed by one or more client model(s) 408 to extract one or more data/information from the client dataset(s) 406 for analysis and/or any other operations.

The documents stored in client dataset(s) 406 may be queried, searched, and/or retrieved and their representations (e.g., representation(s) 412) may be provided to the federated document learning engine 150. For example, the federated document learning engine 150 may receive a representation(s) 412 of all or particular sales agreements in the client dataset(s) 406 for the purposes of generating of model weight(s) 218.

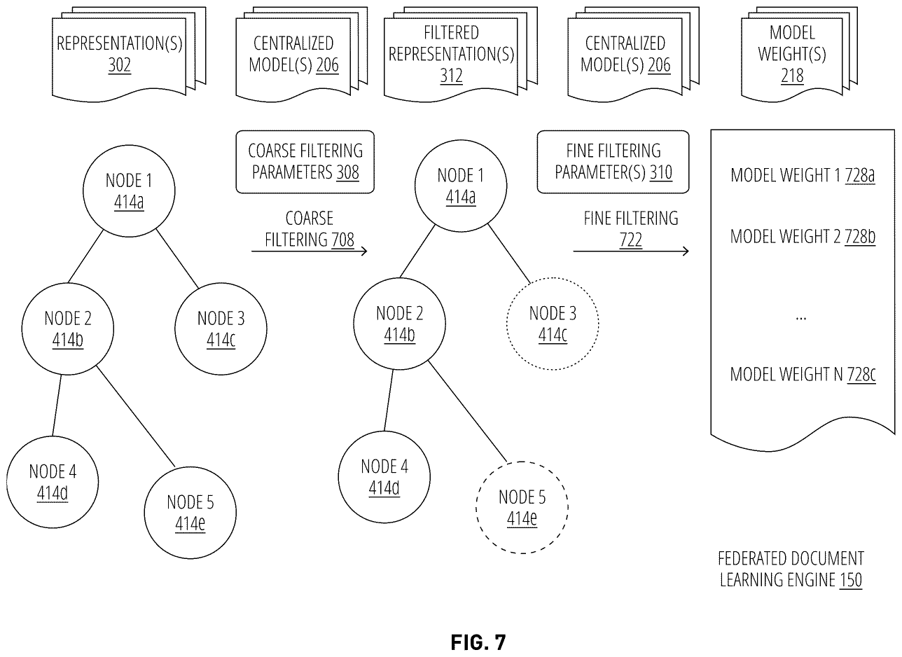

FIG. 7 illustrates an example filtering process that may be performed by the federated document learning engine 150, according to some embodiments of the current subject matter. As shown in FIG. 7, the engine 150 may be configured to receive one or more representation(s) 302, and, if necessary or desired, generate one or more combined representations (e.g., from multiple representation(s) 302). The representation(s) 302 may include a particular arrangement of nodes or elements (that may correspond to features (e.g., legal document, sales agreement, etc.) in the documents contained in client dataset(s) 406). As shown in FIG. 4, an example representation(s) 302 may include a hierarchical structure having multiple elements or nodes 414 (e.g., node 1 414a may correspond to a type-legal agreement; node 2 414b may correspond to a sales agreement; node 3 414c may correspond to a lease agreement; node 4 414d may correspond to a sales agreement with a large corporation; and node 5 414c may correspond to a sales agreement with a small corporation). As can be understood, the nodes 414 may be linked based on type of data and/or relevancy of data and/or may arranged in any desired fashion (e.g., a list, a catalog, etc.).

The federated document learning engine 150 may then apply coarse filtering 708 (e.g., using centralized model(s) 206) to the representation(s) 302. The coarse filtering 708 may be applied using one or more coarse filtering parameters 308 (e.g., “remove features of non-sales agreements”). Such coarse filtering 708 may result in removal of the node 3 414c, which corresponds to a feature of a lease agreement. As a result of coarse filtering 708, filtered representation(s) 312 may be generated by the federated document learning engine 150.

The federated document learning engine 150 may then be configured to apply fine filtering 722 (e.g., using centralized model(s) 206) using one or more fine filtering parameter(s) 310 (e.g., “remove features of sales agreements with small corporations”). This may result in removal of node 5 414c (corresponding to a feature of a sales agreement with a small corporation). As a result of the fine filtering 722, the federated document learning engine 150 may be configured to generate (e.g., using centralized model(s) 206) one or more model weight(s) 218, which may include model weight 1 728a (e.g., corresponding to a feature of a “legal document”), model weight 2 728b (e.g., corresponding to a feature of a “sales agreement”), . . . model weight n 728c (e.g., corresponding toa feature of a “sales agreement with a large corporation”), etc. As can be understood any other types of model weight(s) 218 may be generated by the federated document learning engine 150. The model weight(s) 218 may then be provided to client systems (not shown in FIG. 7).

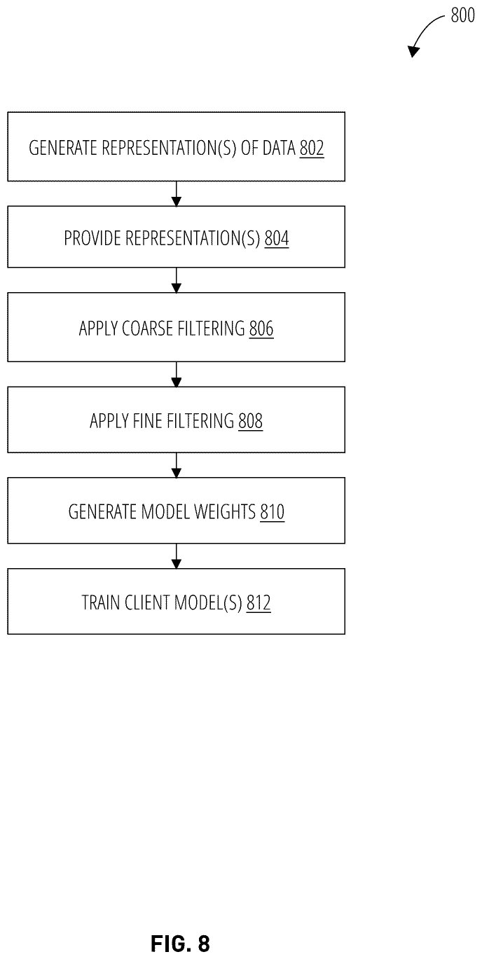

FIG. 8 illustrates an example process 800 for federated document learning, according to some embodiments of the current subject matter. The process 800 may be executed using the federated document learning engine 150 as well as other components shown in FIGS. 1-3.

At 802, the federated document learning engine 150 may be configured to receive one or more representation(s) 412 generated by one or more client systems 400 using one or more public model(s) 208 provided, at 804, to it by the engine 150. The client system 400 may be configured to generate representation(s) 412 based on one or more electronic documents, such as, for example, electronic document(s) 402 and/or other electronic data 404. The data in such electronic document(s) 402 and/or other electronic data 404 may be structured and/or unstructured. Further, the electronic document(s) 402 and/or other electronic data 404 may be labeled and/or unlabeled. The data in client dataset(s) 406 may come from one or more storage locations and/or sources. For example, data storages may be private databases with various access rights and/or privileges (e.g., internal company databases, specific user access databases, etc.). In some cases, the private databases may store documents in an organized predetermined fashion, which may allow case of access to the electronic documents and/or any portions thereof. For instance, the documents stored in private databases may be labeled, searchable, and/or otherwise, easily identifiable. In other cases, the documents may be stored in such databases in an unstructured format. The electronic document(s) 402 and/or other electronic data 404 may be stored in any desired electronic formats, e.g., PDF, .docx, .xls, etc.

The electronic document(s) 402 and/or other electronic data 404 may also be received from public non-government databases, government databases (e.g., SEC-EDGAR, etc.), etc. and/or any other data sources. These sources may store various legal documents (e.g., commercial contracts, lease agreements, public disclosures, etc.), non-legal documents, and/or any other types of documents. The electronic document(s) 402 and/or other electronic data 404 may be identified using various identifiers allowing location/retrieval of these documents in/from the databases. While the electronic document(s) 402 and/or other electronic data 404 stored in client dataset(s) 406 may be appropriately identified, labeled, etc. and be accessible by the client system 400, the generated representation(s) 412 does not include any data contained in electronic document(s) 402 and/or other electronic data 404.

At 806, the first filtering engine 304 of the federated document learning engine 150 may be configured to perform coarse filtering 708 using one or more coarse filtering parameters 308. In some example embodiments, the engine 304 may be configured to use one or more centralized model(s) 206 to perform coarse filtering 708 of the representation(s) 412 based on the information contained in the document learning query 226. For example, the engine 304 may use document learning query 226 to remove nodes or elements not related to sales agreements (e.g., lease agreements). The engine 304 may also identify other nodes or elements in the representation(s) 412 that may be associated and/or related to the initially identified nodes or elements that are not related to the document learning query 226.

At 808, the second filtering engine 306 of the federated document learning engine 150 may be configured to perform fine filtering 722 using one or more fine filtering parameter(s) 310. The second filtering engine 306 may rely on one or more centralized model(s) 206 to remove nodes or elements that are not related to the document learning query 226 (e.g., remove all sales agreements with small corporations). To remove such data, the engine 306 may use one or more identifiers (e.g., metadata) associated with the nodes or elements in the representation(s) 412. The metadata may include location of the data within the documents, type of data, a format of the data, and/or any other type of metadata.

At 810, the federated document learning engine 150 may be configured to generate one or more model weight(s) 218, which may be used by the client system 400 to perform training 410 of one of its client model(s) 408, at 812.

In some embodiments, one or more users, such as users of client system 400, may provide feedback to the representation(s) 412, model weight(s) 218, etc. For instance, the user may indicate that the client model(s) 408 are not properly responding to queries, which may mean that one or more model weight(s) 218 have not been correctly determined. The feedback may be provided to the federated document learning engine 150, which may use it to update the representation(s) 412, model weight(s) 218, etc., one or more centralized model(s) 206, public model(s) 208, and/or perform any other actions.

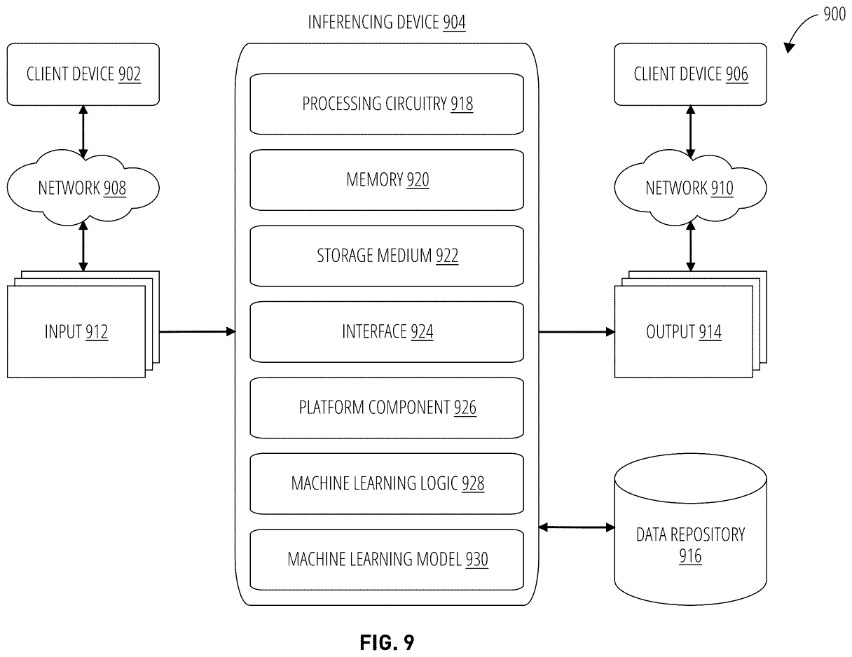

FIG. 9 illustrates an example of an AI/ML system 900 that may be used for generating one or more representation(s), perform filtering, and/or generate one or more model weight(s) 218, according to some embodiments of the current subject matter. The system 900 may include a set of M devices, where M is any positive integer. As shown in FIG. 9, the system 900 may include three devices (M=3), such as a client device 902, an inferencing device 904, and a client device 906. The inferencing device 904 may communicate information with the client device 902 and the client device 906 over a network 908 and a network 910, respectively. The information may include input 912 from the client device 902 and output 914 to the client device 906, or vice-versa. In some embodiments, the input 912 and the output 914 may be communicated between the same client device 902 or client device 906. In another alternative, the input 912 and the output 914 may be stored in a data repository 916. Alternatively, or in addition, the input 912 and the output 914 are communicated via a platform component 926 of the inferencing device 904, such as an input/output (I/O) device (e.g., a touchscreen, a microphone, a speaker, etc.).

As shown in FIG. 9, the inferencing device 904 may include a processing circuitry 918, a memory 920, a storage medium 922, an interface 924, a platform component 926, ML logic 928, and an ML model 930. In some embodiments, the inferencing device 904 may include other components and/or devices as well. Examples for software elements and hardware elements of the inferencing device 904 are described in more detail with reference to a computing architecture 1900 as depicted in FIG. 19. Embodiments are not limited to these examples.

The inferencing device 904 may generally be arranged to receive an input 912, process the input 912 via one or more AI/ML techniques, and send an output 914. The inferencing device 904 may receive the input 912 from the client device 902 via the network 908, the client device 906 via the network 910, the platform component 926 (e.g., a touchscreen as a text command or microphone as a voice command), the memory 920, the storage medium 922 or the data repository 916. The inferencing device 904 may send the output 914 to the client device 902 via the network 908, the client device 906 via the network 910, the platform component 926 (e.g., a touchscreen to present text, graphic or video information or speaker to reproduce audio information), the memory 920, the storage medium 922 or the data repository 916. Examples for the software elements and hardware elements of the network 908 and the network 910 are described in more detail with reference to a communications architecture 2000 as depicted in FIG. 20. Embodiments are not limited to these examples.

The inferencing device 904 may include ML logic 928 and an ML model 930 to implement various AI/ML techniques for various AI/ML tasks. The ML logic 928 may receive the input 912 and process the input 912 using the ML model 930. The ML model 930 may perform inferencing operations to generate an inference for a specific task from the input 912. In some embodiments, the inference is part of the output 914. The output 914 may be used by the client device 902, the inferencing device 904, or the client device 906 to perform subsequent actions in response to the output 914.

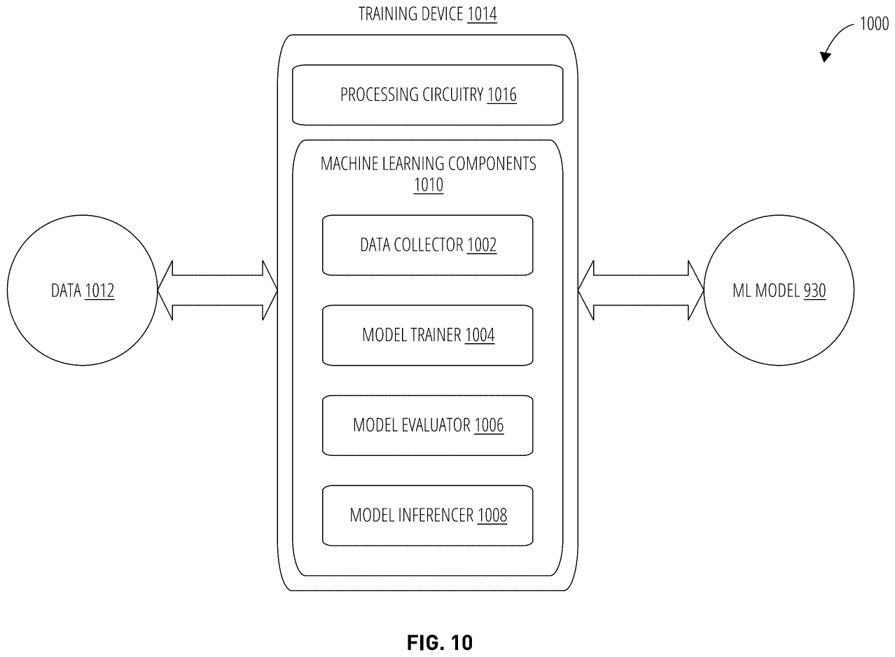

In some embodiments, the ML model 930 may be a trained ML model 930 using a set of training operations. An example of training operations to train the ML model 930 is described with reference to FIG. 10.

FIG. 10 illustrates an example apparatus 1000 that may include a training device 1014 suitable to generate a trained ML model 930 for the inferencing device 904 of the system 900. As shown in FIG. 10, the training device 1014 may include a processing circuitry 1016 and a set of ML components 1010 to support various AI/ML techniques, such as a data collector 1002, a model trainer 1004, a model evaluator 1006 and a model inferencer 1008.

In general, the data collector 1002 may collect data 1012 from one or more data sources to use as training data for the ML model 930. The data collector 1002 may collect different types of data 1012, such as, text information, audio information, image information, video information, graphic information, and so forth. The model trainer 1004 may receive as input the collected data and uses a portion of the collected data as test data for an AI/ML algorithm to train the ML model 930. The model evaluator 1006 may evaluate and improve the trained ML model 330 using a portion of the collected data as test data to test the ML model 930. The model evaluator 1006 may also use feedback information from the deployed ML model 930. The model inferencer 1008 may implement the trained ML model 930 to receive as input new unseen data, generate one or more inferences on the new data, and output a result such as an alert, a recommendation or other post-solution activity.

An exemplary AI/ML architecture for the ML components 1010 is described in more detail with reference to FIG. 11.

FIG. 11 illustrates an artificial intelligence architecture 1100 that may be used by the training device 1014 to generate the ML model 930 (e.g., ML model(s) 320, as shown in FIG. 3) for deployment by the inferencing device 304. The artificial intelligence architecture 1100 is an example of a system suitable for implementing various AI techniques and/or ML techniques to perform various inferencing tasks on behalf of the various devices of the system 100.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1100 may include various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 930, evaluate performance of the trained ML model 930, and deploy the tested ML model 930 as the trained ML model 930 in a production environment, and continuously monitor and maintain it.

The ML model 930 may be a mathematical construct used to predict outcomes based on a set of input data. The ML model 930 may be trained using large volumes of training data 1126, and it can recognize patterns and trends in the training data 1126 to make accurate predictions. The ML model 930 may be derived from an ML algorithm 1124 (e.g., a neural network, decision tree, support vector machine, etc.). A data set is fed into the ML algorithm 1124 which trains an ML model 930 to “learn” a function that produces mappings between a set of inputs and a set of outputs with a reasonably high accuracy. Given a sufficiently large enough set of inputs and outputs, the ML algorithm 1124 may find the function for a given task. This function may even be able to produce the correct output for input that it has not seen during training. A data scientist prepares the mappings, selects and tunes the ML algorithm 1124, and evaluates the resulting model performance. Once the ML logic 928 is sufficiently accurate on test data, it can be deployed for production use.

The ML algorithm 1124 may include any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1124 of the artificial intelligence architecture 1100 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 11, the artificial intelligence architecture 1100 includes a set of data sources 1102 to source data 1104 for the artificial intelligence architecture 1100. Data sources 1102 may comprise any device capable generating, processing, storing or managing data 1104 suitable for a ML system. The data sources 1102 may receive data 1150 associated with documents (e.g., type of documents, portion(s) of document content(s) and/or entire contents of document(s), transactions data (e.g., type of transaction, transaction identifier, requests associated with the transaction, etc.), and/or any other data. It should be noted that the data 1150 may also be supplied during training phase of the model. Some additional, non-limiting, examples of data sources 1102 include without limitation databases, web scraping, sensors and Internet of Things (IOT) devices, image and video cameras, audio devices, text generators, publicly available databases, private databases, and many other data sources 1102. The data sources 1102 may be remote from the artificial intelligence architecture 1100 and accessed via a network, local to the artificial intelligence architecture 1100 an accessed via a network interface or may be a combination of local and remote data sources 1102.

The data sources 1102 source difference types of data 1104 (which may include data 1150 related to documents, transactions, etc.). By way of example and not limitation, the data 1104 includes structured data from relational databases, such as customer profiles, transaction histories, or product inventories. The data 1104 includes unstructured data from websites such as customer reviews, news articles, social media posts, or product specifications. The data 1104 includes data from temperature sensors, motion detectors, and smart home appliances. The data 1104 includes image data from medical images, security footage, or satellite images. The data 1104 includes audio data from speech recognition, music recognition, or call centers. The data 1104 includes text data from emails, chat logs, customer feedback, news articles or social media posts. The data 1104 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1104 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1102 may be communicatively coupled to a data collector 1002. The data collector 1002 may gather relevant data 1104 from the data sources 1102. Once collected, the data collector 1002 may use a pre-processor 1106 to make the data 1104 suitable for analysis. This may involve data cleaning, transformation, and feature engineering. Data preprocessing is a critical step in ML as it directly impacts the accuracy and effectiveness of the ML model 930. The pre-processor 1106 receives the data 1104 as input, processes the data 1104, and outputs pre-processed data 1116 for storage in a database 1108. Examples for the database 1108 includes a hard drive, solid state storage, and/or random-access memory (RAM).

The data collector 1002 is communicatively coupled to a model trainer 1004. The model trainer 1004 may perform AI/ML model training, validation, and testing which may generate model performance metrics as part of the model testing procedure. The model trainer 1004 may receive the pre-processed data 1116 as input 1110 or via the database 1108. The model trainer 1004 may implement a suitable ML algorithm 1124 to train an ML model 930 on a set of training data 1126 from the pre-processed data 1116. The training process may involve feeding the pre-processed data 1116 into the ML algorithm 1124 to produce or optimize an ML model 930. The training process may adjust its parameters until it achieves an initial level of satisfactory performance.

The model trainer 1004 may be communicatively coupled to a model evaluator 1006. After an ML model 930 is trained, the ML model 930 may need to be evaluated to assess its performance. This is done using various metrics such as accuracy, precision, recall, and FI score. The model trainer 1004 may output the ML model 930, which is received as input 1110 or from the database 1108. The model evaluator 1006 may receive the ML model 930 as input 1112, and it initiates an evaluation process to measure performance of the ML model 930. The evaluation process may include providing feedback 1118 to the model trainer 404. The model trainer 1004 may re-train the ML model 930 to improve performance in an iterative manner.

The model evaluator 1006 may be communicatively coupled to the model inferencer 1008. The model inferencer 1008 may provide AI/ML model inference output (e.g., inferences, predictions or decisions). Once the ML model 930 is trained and evaluated, it may be deployed in a production environment where it is used to make predictions on new data. The model inferencer 1008 may receive the evaluated ML model 930 as input 1114. The model inferencer 1008 may use the evaluated ML model 930 to produce insights or predictions on real data, which may be deployed as a final production ML model 930. The inference output of the ML model 930 may be use case specific. The model inferencer 1008 may also perform model monitoring and maintenance, which involves continuously monitoring performance of the ML model 930 in the production environment and making any necessary updates or modifications to maintain its accuracy and effectiveness. The model inferencer 1008 may provide feedback 1118 to the data collector 1002 to train or re-train the ML model 930. The feedback 1118 may include model performance feedback information, which may be used for monitoring and improving performance of the ML model 330.

Some or all of the model inferencer 408 may be implemented by various actors 1122 in the artificial intelligence architecture 1100, including the ML model 930 of the inferencing device 904, for example. The actors 1122 may use the deployed ML model 930 on new data to make inferences or predictions for a given task and output an insight 1132. The actors 1122 may implement the model inferencer 1008 locally, or remotely receives outputs from the model inferencer 1008 in a distributed computing manner. The actors 1122 may trigger actions directed to other entities or to itself. The actors 1122 provide feedback 1120 to the data collector 1002 via the model inferencer 408. The feedback 1120 may include data needed to derive training data, inference data or to monitor the performance of the ML model 930 and its impact to the network through updating of key performance indicators (KPIs) and performance counters.

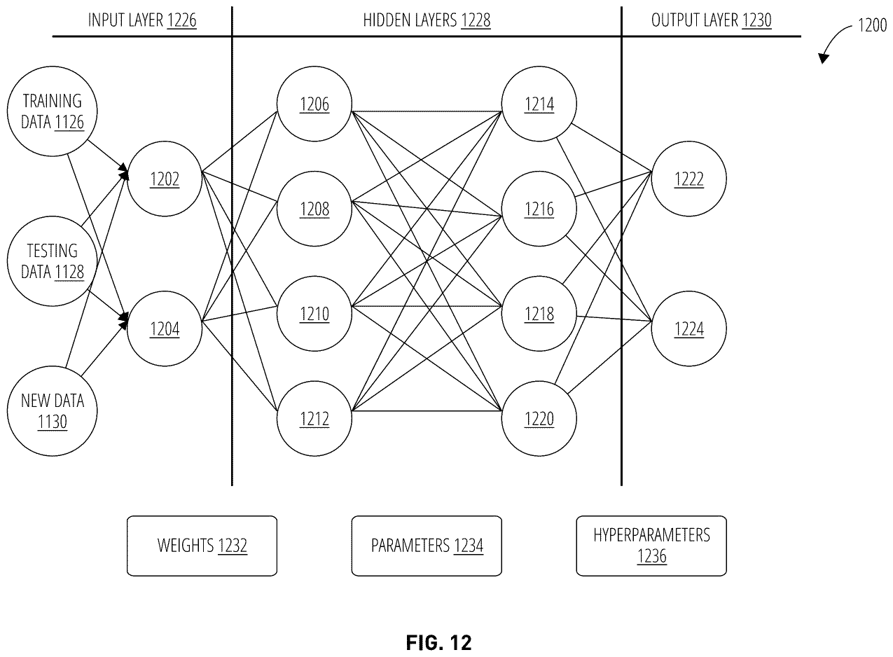

As discussed above, the systems 100, 900 implement some or all of the artificial intelligence architecture 1100 to support various use cases and solutions for various AI/ML tasks. In some embodiments, the training device 1014 of the apparatus 1000 may use the artificial intelligence architecture 1100 to generate and train the ML model 930 for use by the inferencing device 904 for the system 100. In one embodiment, for example, the training device 1014 may train the ML model 930 as a neural network, as described in more detail with reference to FIG. 12. Other use cases and solutions for AI/ML are possible as well, and embodiments are not limited in this context.

FIG. 12 illustrates an embodiment of an artificial neural network 1200. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1200 may include multiple node layers, containing an input layer 1226, one or more hidden layers 1228, and an output layer 1230. Each layer comprises one or more nodes, such as nodes 1202 to 1224. As shown in FIG. 12, for example, the input layer 1226 may include nodes 1202, 1204. The artificial neural network 1200 may include two hidden layers 1228, with a first hidden layer having nodes 1206, 1208, 1210 and 1212, and a second hidden layer having nodes 1214, 1216, 1218 and 1220. The artificial neural network 1200 may include an output layer 1230 with nodes 1222, 1224. Each node 1202 to 1224 may include a processing element (PE), or artificial neuron, which connects to another and has an associated weight and threshold. If the output of any individual node is above the specified threshold value, that node may be activated, sending data to the next layer of the network. Otherwise, no data is passed along to the next layer of the network.

In general, artificial neural network 1200 may rely on training data 1126 to learn and improve accuracy over time. However, once the artificial neural network 1200 may be fine-tuned for accuracy, and tested on testing data 1128, the artificial neural network 1200 may be ready to classify and cluster new data 1130 at a high velocity. Tasks in speech recognition or image recognition can take minutes versus hours when compared to the manual identification by human experts.

Each individual node 1202 to 424 may be a linear regression model, composed of input data, weights, a bias (or threshold), and an output. The linear regression model may have a formula similar to Equation (1), as follows:

$$\sum wixi + bias = w 1 x 1 + w 2 x 2 + w 3 x 3 + bias \qquad EQUATION ( 1 )$$

$$output = f ( x ) = 1 if \sum w 1 x 1 + b >= 0 ; 0 if \sum w 1 x 1 + b < 0$$

Once an input layer 1226 is determined, a set of weights 1232 may be assigned. The weights 1232 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1200 as a feedforward network.

In some embodiments, the artificial neural network 1200 may leverage sigmoid neurons, which are distinguished by having values between 0 and 1. Since the artificial neural network 1200 behaves similarly to a decision tree, cascading data from one node to another, having x values between 0 and 1 will reduce the impact of any given change of a single variable on the output of any given node, and subsequently, the output of the artificial neural network 1200.

The artificial neural network 1200 may have many practical use cases, like image recognition, speech recognition, text recognition or classification. The artificial neural network 1200 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{m} {( \hat{{y}_{i}} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1234 of the model adjust to gradually converge at the minimum.

In one embodiment, the artificial neural network 1200 is feedforward, meaning it flows in one direction only, from input to output. In one embodiment, the artificial neural network 1200 uses backpropagation. Backpropagation is when the artificial neural network 1200 moves in the opposite direction from output to input. Backpropagation allows calculation and attribution of errors associated with each neuron 1202 to 1224, thereby allowing adjustment to fit the parameters 1234 of the ML model 930 appropriately.

The artificial neural network 1200 is implemented as different neural networks depending on a given task. Neural networks are classified into different types, which are used for different purposes. In one embodiment, the artificial neural network 1200 is implemented as a feedforward neural network, or multi-layer perceptrons (MLPs), comprised of an input layer 1226, hidden layers 1228, and an output layer 1230. While these neural networks are also commonly referred to as MLPs, they are actually comprised of sigmoid neurons, not perceptrons, as most real-world problems are nonlinear. Trained data 1104 usually is fed into these models to train them, and they are the foundation for computer vision, natural language processing, and other neural networks. In one embodiment, the artificial neural network 1200 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1200 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1200 is implemented as any type of neural network suitable for a given operational task of system 100, and the MLP, CNN, and RNN are merely a few examples. Embodiments are not limited in this context.

The artificial neural network 1200 may include a set of associated parameters 1234. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some embodiments, the artificial neural network 1200 may be implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1236. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

FIG. 13 illustrates an example of a document corpus 1308 suitable for use by the federated document learning engine 150 of the server device 102. The document corpus 1308 may be stored in one or more database and/or storage locations and may be accessible (e.g., via a query) by the federated document learning engine 150. In general, a document corpus is a large and structured collection of electronic documents, such as text documents, which are typically used for natural language processing (NLP) tasks such as text classification, sentiment analysis, topic modeling, and information retrieval. A corpus can include a variety of document types such as web pages, books, news articles, social media posts, scientific papers, and more. The corpus may be created for a specific domain or purpose, and it may be annotated with metadata or labels to facilitate analysis. Document corpora are commonly used in research and industry to train machine learning models and to develop NLP applications.

As shown in FIG. 13, the document corpus 1308 may include information from electronic documents 1318 derived from the document records 138 stored in the data store 126. The electronic documents 1318 may include any electronic document having metadata such as STME 132 suitable for receiving an electronic signature, including both signed electronic documents or unsigned electronic documents. Different sets of the electronic documents 1318 of the document corpus 1308 may be associated with different entities. For example, a first set of electronic documents 1318 is associated with a company A 1302. A second set of electronic documents 1318 is associated with a company B 1304. A third set of electronic documents 1318 is associated with a company C 1306. A fourth set of electronic documents 1318 is associated with a company D 1310. Although some embodiments discuss the document corpus 1308 having electronic documents 1318, it may be appreciated that the document corpus 1308 may have unsigned electronic document as well, which may be mined using the AI/ML techniques described herein. Embodiments are not limited in this context.

Each set of electronic documents 1318 associated with a defined entity may include one or more subsets of the electronic documents 1318 categorized by document type. For instance, the second set of electronic documents 1318 associated with company B 1304 may have a first subset of electronic documents 1318 with a document type for supply agreements 1312, a second subset of electronic documents 1318 with a document type for lease agreements 1316, and a third subset of electronic documents 1318 with a document type for service agreements 1314. In one embodiment, the sets and subsets of electronic documents 1318 may be identified using labels manually assigned by a human operator, such as metadata added to a document record for a signed electronic document created in a document management system, or feedback from a user of the system 100 during a document generation process. In one embodiment, the sets and subsets of electronic documents 1318 may be unlabeled.

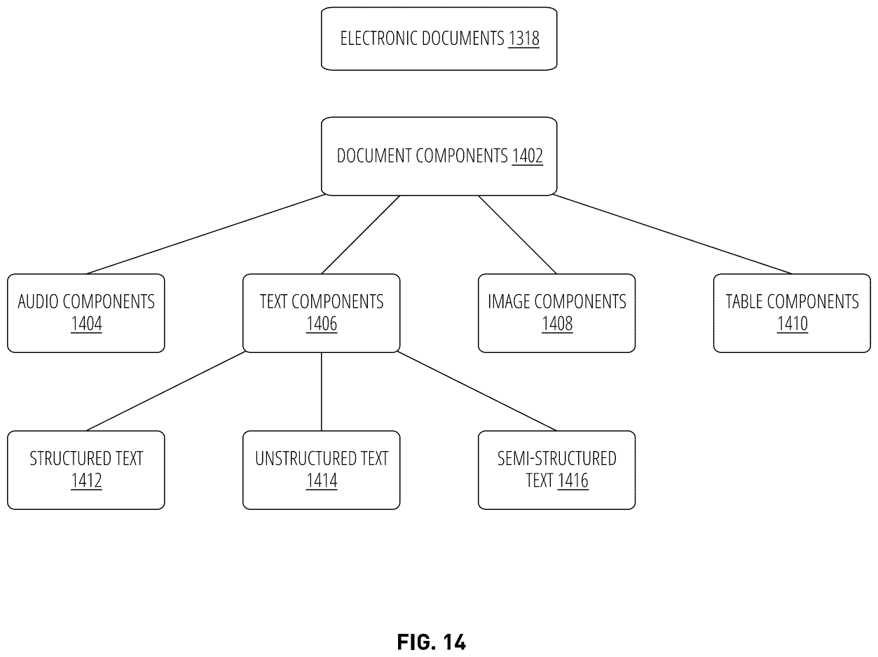

FIG. 14 illustrates an example of an electronic document 1318. An electronic document 1318 may include different information types that collectively form a set of document components 1402 for the electronic document 1318. The document components 1402 may comprise, for example, one or more audio components 1404, text components 1406, image components 1408, or table components 1410. Each document component 1402 may comprise different content types. For example, the text components 1406 may comprise structured text 1412, unstructured text 1414, or semi-structured text 1416.

Structured text 1412 refers to text information that is organized in a specific format or schema, such as words, sentences, paragraphs, sections, clauses, and so forth. Structured text 1412 has a well-defined set of rules that dictate how the data should be organized and represented, including the data types and relationships between data elements.

Unstructured text 1414 refers to text information that does not have a predefined or organized format or schema. Unlike structured text 1412, which is organized in a specific way, unstructured text 1414 can take various forms, such as text information stored in a table, spreadsheet, figures, equations, header, footer, filename, metadata, and so forth.

Semi-structured text 1416 is text information that does not fit neatly into the traditional categories of structured and unstructured data. It has some structure but does not conform to the rigid structure of a specific format or schema. Semi-structured data is characterized by the presence of context tags or metadata that provide some structure and context for the text information, such as a caption or description of a figure, name of a table, labels for equations, and so forth.

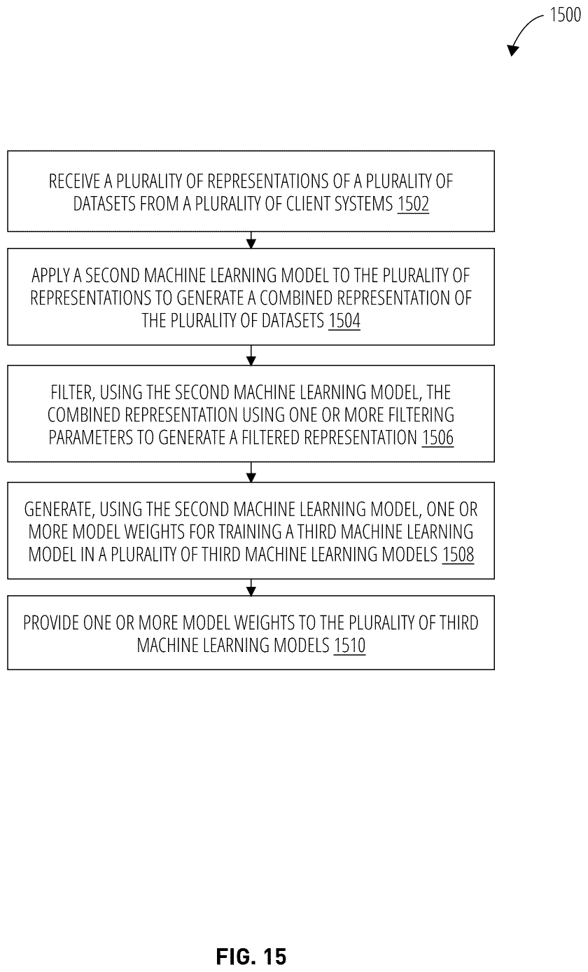

FIG. 15 illustrates another example method 1500 for performing federated document learning, according to some embodiments of the current subject matter. The method 1500 may be executed using system 100 shown in FIG. 1, and in particular using the federated document learning engine 150.

At 1502, the federated document learning engine 150 may receive a plurality of representations (e.g., representation(s) 302) of a plurality of datasets (e.g., client dataset(s) 406) from a plurality of client systems (e.g., client systems 400). A representation in the plurality of representations may correspond to a dataset associated with a client system in the plurality of client systems. Each representation in the plurality of representations may be generated using a first machine learning model (e.g., public model(s) 208).

At 1504, the federated document learning engine 150 may apply a second machine learning model (e.g., centralized model(s) 206) to the plurality of representations to generate a combined representation of the plurality of datasets. Data from each dataset in the plurality of datasets is not provided to the second machine learning model.

At 1506, the engine 150 may filter, using the second machine learning model, the combined representation using one or more filtering parameters (e.g., coarse filtering parameters 308 and/or fine filtering parameter(s) 310) to generate a filtered representation (e.g., filtered representation(s) 312).

At 1508, the federated document learning engine 150 may generate, using the second machine learning model, one or more model weights (e.g., model weight(s) 218) for training (e.g., training 410) a third machine learning model (e.g., client model client model(s) 408) in a plurality of third machine learning models. Each third machine learning model is associated with a respective client system (e.g., client system 400).

At 1510, the engine 150 may provide one or more model weights to the plurality of third machine learning models.

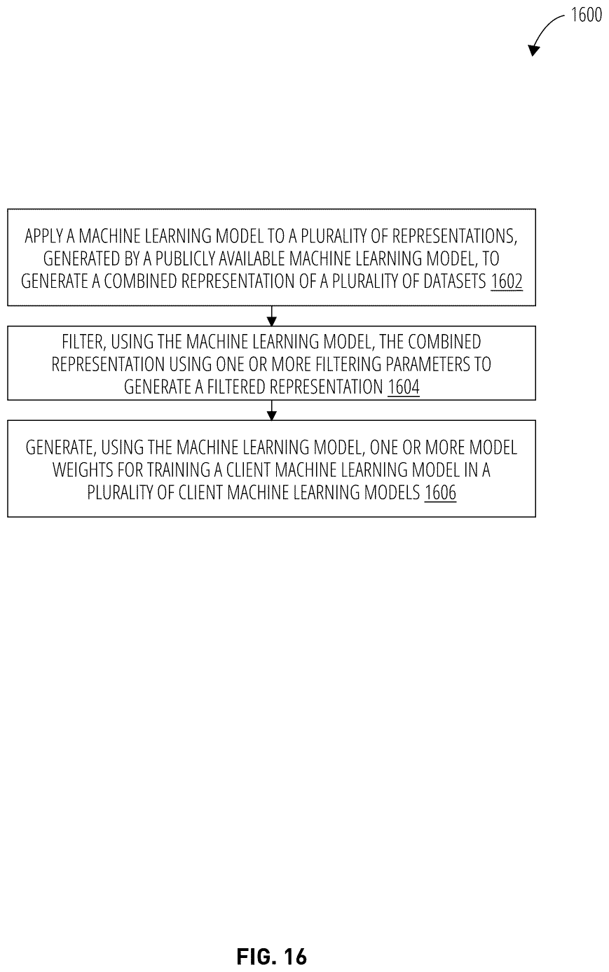

FIG. 16 illustrates another example method 1600 for performing federated document learning, according to some embodiments of the current subject matter. The method 1600 may be executed using system 100 shown in FIG. 1, and in particular using the federated document learning engine 150.

At 1602, the federated document learning engine 150 may apply a machine learning model (e.g., centralized model(s) 206) to a plurality of representations (e.g., representation(s) 302), generated by a publicly available machine learning model (e.g., public model(s) 208), to generate a combined representation of a plurality of datasets (e.g., client dataset(s) 214). Each dataset is associated with a respective client system (e.g., client system 210) in a plurality of client systems. Data in each dataset is not provided to the machine learning model.

At 1604, the first filtering engine 304 of the federated document learning engine 150 may filter, using the machine learning model, the combined representation using one or more filtering parameters (e.g., coarse filtering parameters 308 and/or fine filtering parameter(s) 310) to generate a filtered representation (e.g., filtered representation(s) 312).

At 1606, the federated document learning engine 150 may generate, using the machine learning model, one or more model weights (e.g., model weight(s) 218) for training (e.g., training 410) a client machine learning model (e.g., client model 212) in a plurality of client machine learning models. Each client machine learning model is associated with a respective client system.

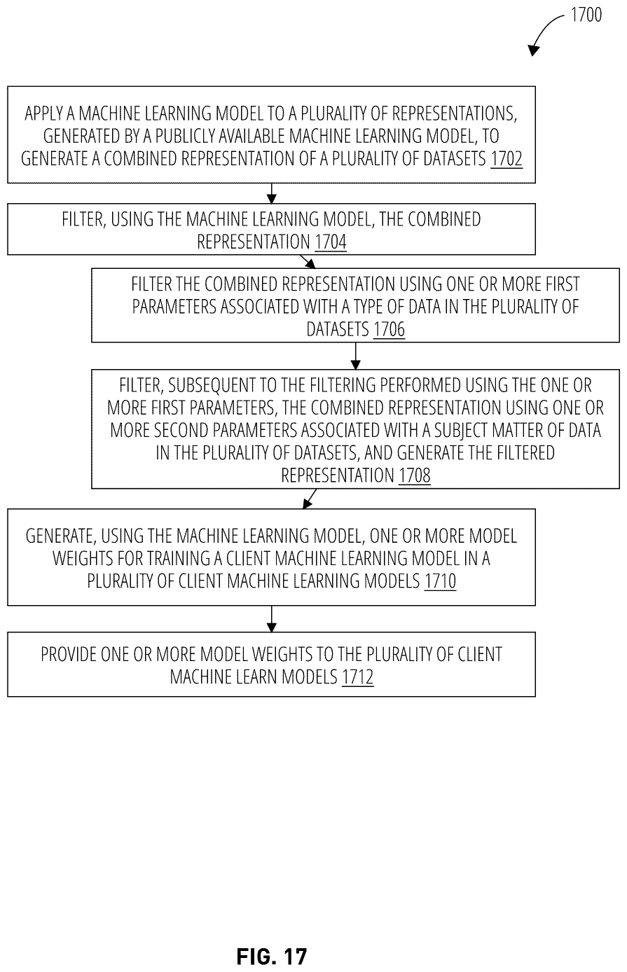

FIG. 17 illustrates yet another example method 1700 for performing federated document learning, according to some embodiments of the current subject matter. The method 1700 may be executed using system 100 shown in FIG. 1, and in particular using the federated document learning engine 150.

At 1702, the federated document learning engine 150 may apply a machine learning model (e.g., centralized model(s) 206) to a plurality of representations generated by a publicly available machine learning model (e.g., public model(s) 208), to generate a combined representation of a plurality of datasets (e.g., client dataset(s) 214). Each dataset in the plurality of datasets is associated with a respective client system (e.g., client system(s) 210) in a plurality of client systems. Data in each dataset is not provided to the machine learning model.

At 1704, the engine 150 may filter, using the machine learning model, the combined representation by filtering, at 1706, the combined representation using one or more first parameters (e.g., coarse filtering parameters 308) associated with a type of data in the plurality of datasets, and filtering, at 1708, subsequent to the filtering performed using the one or more first parameters, the combined representation using one or more second parameters (e.g., fine filtering parameter(s) 310) associated with a subject matter of data in the plurality of datasets, and generating the filtered representation (e.g., filtered representation(s) 312).

At 1710, the federated document learning engine 150 may generate, using the machine learning model, one or more model weights (e.g., model weight(s) 218) for training (e.g., training 410) a client machine learning model (e.g., client model(s) 212) in a plurality of client machine learning models. Each client machine learning model is associated with a respective client system.

At 1712, the engine 150 may provide one or more model weights to the plurality of client machine learns models. Each client system may be configured to train its client machine learning model using the one or more model weights.

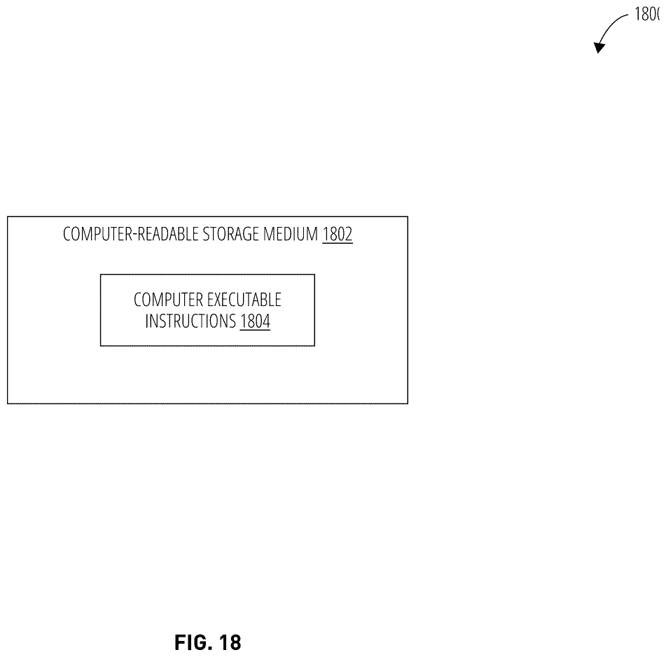

FIG. 18 illustrates an apparatus 1800. Apparatus 1800 may comprise any non-transitory computer-readable storage medium 1802 or machine-readable storage medium, such as an optical, magnetic or semiconductor storage medium. In various embodiments, apparatus 1800 may comprise an article of manufacture or a product. In some embodiments, the computer-readable storage medium 1802 may store computer executable instructions with which circuitry can execute. For example, computer executable instructions 1804 can include instructions to implement operations described with respect to any logic flows described herein. Examples of computer-readable storage medium 1802 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1804 may include any suitable type of code, such as source code, compiled code, interpreted code, executable code, static code, dynamic code, object-oriented code, visual code, and the like.

FIG. 19 illustrates an embodiment of a computing architecture 1900. Computing architecture 1900 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1900 may have a single processor with one core or more than one processor. Note that the term “processor” refers to a processor with a single core or a processor package with multiple processor cores. In at least one embodiment, the computing architecture 1900 is representative of the components of the system 100. More generally, the computing architecture 1900 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 19, computing architecture 1900 comprises a system-on-chip (SoC) 1902 for mounting platform components. System-on-chip (SoC) 1902 is a point-to-point (P2P) interconnect platform that includes a first processor 1904 and a second processor 1906 coupled via a point-to-point interconnect 1970 such as an Ultra Path Interconnect (UPI). In other embodiments, the computing architecture 1900 may be of another bus architecture, such as a multi-drop bus. Furthermore, each of processor 1904 and processor 1906 may be processor packages with multiple processor cores including core(s) 1908 and core(s) 1910, respectively. While the computing architecture 1900 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 1904 and chipset 1932. Some platforms may include additional components and some platforms may only include sockets to mount the processors and/or the chipset. Furthermore, some platforms may not have sockets (e.g., SoC, or the like). Although depicted as a SoC 1902, one or more of the components of the SoC 1902 may also be included in a single die package, a multi-chip module (MCM), a multi-die package, a chiplet, a bridge, and/or an interposer. Therefore, embodiments are not limited to a SoC.

The processor 1904 and processor 1906 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 1904 and/or processor 1906. Additionally, the processor 1904 need not be identical to processor 1906.

Processor 1904 includes an integrated memory controller (IMC) 1920 and point-to-point (P2P) interface 1924 and P2P interface 1928. Similarly, the processor 1906 includes an IMC 1922 as well as P2P interface 1926 and P2P interface 1930. IMC 1920 and IMC 1922 couple the processor 1904 and processor 1906, respectively, to respective memories (e.g., memory 1916 and memory 1918). Memory 1916 and memory 1918 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 1916 and the memory 1918 locally attach to the respective processors (i.e., processor 1904 and processor 1906). In other embodiments, the main memory may couple with the processors via a bus and shared memory hub. Processor 1904 includes registers 1912 and processor 1906 includes registers 1914.

Computing architecture 1900 includes chipset 1932 coupled to processor 1904 and processor 1906. Furthermore, chipset 1932 can be coupled to storage device 1950, for example, via an interface (I/F) 1938. The I/F 1938 may be, for example, a Peripheral Component Interconnect-enhanced (PCIe) interface, a Compute Express Link® (CXL) interface, or a Universal Chiplet Interconnect Express (UCIe) interface. Storage device 1950 can store instructions executable by circuitry of computing architecture 1900 (e.g., processor 1904, processor 1906, GPU 1948, accelerator 1954, vision processing unit 1956, or the like). For example, storage device 1950 can store instructions for server device 102, client devices 112, client devices 116, or the like.

Processor 1904 couples to the chipset 1932 via P2P interface 1928 and P2P 1934 while processor 1906 couples to the chipset 1932 via P2P interface 1930 and P2P 1936. Direct media interface (DMI) 1976 and DMI 1978 may couple the P2P interface 1928 and the P2P 1934 and the P2P interface 1930 and P2P 1936, respectively. DMI 1976 and DMI 1978 may be a high-speed interconnect that facilitates, e.g., eight Giga Transfers per second (GT/s) such as DMI 3.0. In other embodiments, the processor 1904 and processor 1906 may interconnect via a bus.

The chipset 1932 may comprise a controller hub such as a platform controller hub (PCH). The chipset 1932 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1932 may comprise more than one controller hub such as a chipset with a memory controller hub, a graphics controller hub, and an input/output (I/O) controller hub.

In the depicted example, chipset 1932 couples with a trusted platform module (TPM) 1944 and UEFI, BIOS, FLASH circuitry 1946 via I/F 1942. The TPM 1944 is a dedicated microcontroller designed to secure hardware by integrating cryptographic keys into devices. The UEFI, BIOS, FLASH circuitry 1946 may provide pre-boot code. The I/F 1942 may also be coupled to a network interface circuit (NIC) 1980 for connections off-chip.

Furthermore, chipset 1932 includes the I/F 1938 to couple chipset 1932 with a high-performance graphics engine, such as, graphics processing circuitry or a graphics processing unit (GPU) 1948. In other embodiments, the computing architecture 1900 may include a flexible display interface (FDI) (not shown) between the processor 1904 and/or the processor 1906 and the chipset 1932. The FDI interconnects a graphics processor core in one or more of processor 1904 and/or processor 1906 with the chipset 1932.

The computing architecture 1900 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 1954 and/or vision processing unit 1956 can be coupled to chipset 1932 via I/F 1938. The accelerator 1954 is representative of any type of accelerator device (e.g., a data streaming accelerator, cryptographic accelerator, cryptographic co-processor, an offload engine, etc.). One example of an accelerator 1954 is the Intel® Data Streaming Accelerator (DSA). The accelerator 1954 may be a device including circuitry to accelerate copy operations, data encryption, hash value computation, data comparison operations (including comparison of data in memory 1916 and/or memory 1918), and/or data compression. For example, the accelerator 1954 may be a USB device, PCI device, PCIe device, CXL device, UCIe device, and/or an SPI device. The accelerator 1954 can also include circuitry arranged to execute machine learning (ML) related operations (e.g., training, inference, etc.) for ML models. Generally, the accelerator 1954 may be specially designed to perform computationally intensive operations, such as hash value computations, comparison operations, cryptographic operations, and/or compression operations, in a manner that is more efficient than when performed by the processor 1904 or processor 1906. Because the load of the computing architecture 1900 may include hash value computations, comparison operations, cryptographic operations, and/or compression operations, the accelerator 1954 can greatly increase performance of the computing architecture 1900 for these operations.

The accelerator 1954 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 1954. For example, the accelerator 1954 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1954 via a non-posted write (e.g., a deferred memory write (DMWr)). One example of an instruction that atomically submits a work descriptor to the shared work queue of the accelerator 1954 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1954. The dedicated work queue may accept job submissions via commands such as the movdir64b instruction.

Various I/O devices 1960 and display 1952 couple to the bus 1972, along with a bus bridge 1958 which couples the bus 1972 to a second bus 1974 and an I/F 1940 that connects the bus 1972 with the chipset 1932. In one embodiment, the second bus 1974 may be a low pin count (LPC) bus. Various devices may couple to the second bus 1974 including, for example, a keyboard 1962, a mouse 1964 and communication devices 1966.

Furthermore, an audio I/O 1968 may couple to second bus 1974. Many of the I/O devices 1960 and communication devices 1966 may reside on the system-on-chip (SoC) 1902 while the keyboard 1962 and the mouse 1964 may be add-on peripherals. In other embodiments, some or all the I/O devices 1960 and communication devices 1966 are add-on peripherals and do not reside on the system-on-chip (SoC) 1902.

FIG. 20 illustrates a block diagram of an exemplary communications architecture 2000 suitable for implementing various embodiments as previously described. The communications architecture 2000 includes various common communications elements, such as a transmitter, receiver, transceiver, radio, network interface, baseband processor, antenna, amplifiers, filters, power supplies, and so forth. The embodiments, however, are not limited to implementation by the communications architecture 2000.

As shown in FIG. 20, the communications architecture 2000 includes one or more clients 2002 and servers 2004. The clients 2002 may implement a client version of the server device 102, for example. The servers 2004 may implement a server version of the server device 102, for example. The clients 2002 and the servers 2004 are operatively connected to one or more respective client data stores 2008 and server data stores 2010 that can be employed to store information local to the respective clients 2002 and servers 2004, such as cookies and/or associated contextual information.

The clients 2002 and the servers 2004 may communicate information between each other using a communication framework 2006. The communications communication framework 2006 may implement any well-known communications techniques and protocols. The communications communication framework 2006 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

(117) The communication framework 2006 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 2002 and the servers 2004. A communications network may be any one and the combination of wired and/or wireless networks including without limitation a direct interconnection, a secured custom connection, a private network (e.g., an enterprise intranet), a public network (e.g., the Internet), a Personal Arca Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose, or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-20 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

The following examples pertain to further embodiments, from which numerous permutations and configurations will be apparent.

In one aspect, a computer-implemented method may include receiving, using at least one processor, a plurality of representations of a plurality of datasets from a plurality of client systems, a representation in the plurality of representations corresponds to a dataset associated with a client system in the plurality of client systems, wherein each representation in the plurality of representations is generated using a first machine learning model; applying, using the at least one processor, a second machine learning model to the plurality of representations to generate a combined representation of the plurality of datasets, wherein data from each dataset in the plurality of datasets is not provided to the second machine learning model; filtering, using the at least one processor, using the second machine learning model, the combined representation using one or more filtering parameters to generate a filtered representation, wherein the one or more filtering parameters are associated with a learning query, the learning query identifying at least one subject matter associated with data in the plurality of datasets; generating, using the at least one processor, using the second machine learning model, one or more model weights for training a third machine learning model in a plurality of third machine learning models, wherein each third machine learning model is associated with a respective client system; and providing, using the at least one processor, the one or more model weights to the plurality of third machine learning models.

The method may include wherein each representation in the plurality of representations identifies one or more features of data in the respective dataset in the plurality of datasets.

The method may include wherein the one or more features of the dataset includes at least one of the following: a type of data, a subtype of data, one or more identifiers of data, a metadata, and any combination thereof.

The method may include wherein the filtering using at least one of: the one or more first and second parameters includes removing at least one feature in one or more features not related to the learning query from the combined representation.

The method may include wherein one or more representations in the plurality of representations includes a hierarchical representation.

The method may include wherein one or more representations in the plurality of representations includes a catalog of data in the respective dataset.

The method may include wherein the first machine learning model is a publicly available machine learning model.

The method may include wherein the filtering includes filtering the combined representation using one or more first parameters associated with a type of data in the plurality of datasets identified by the learning query.

The method may include wherein the filtering includes filtering, subsequent to the filtering performed using the one or more first parameters, the combined representation using one or more second parameters associated with a subject matter of data in the plurality of datasets identified by the learning query, and generating the filtered representation.

The method may include wherein each client system is configured to train its third machine learning model using the one or more model weights.

The method may include wherein at least one of the first, second and third machine learning models include at least one of the following: a generative artificial intelligence (AI) model, a large language model, and any combination thereof.

The method may include wherein the data in one or more datasets in the plurality of datasets includes at least one of: a legal document, a non-legal document, an agreement, a text, an image, a graphic, a video, an audio, a clause in the electronic document, a sentence in the electronic document, a paragraph in the electronic document, a predetermined number of characters in the electronic document, and any combination thereof.

In one aspect, a system may include at least one processor; and at least one memory storing instructions that, when executed by the at least one processor, cause the at least one processor to: apply a machine learning model to a plurality of representations, generated by a publicly available machine learning model, to generate a combined representation of a plurality of datasets, wherein each dataset in the plurality of datasets is associated with a respective client system in a plurality of client systems, wherein data in each dataset is not provided to the machine learning model; filter, using the machine learning model, the combined representation using one or more filtering parameters to generate a filtered representation, wherein the one or more filtering parameters are associated with a learning query, the learning query identifying at least one subject matter associated with data in the plurality of datasets; and generate, using the machine learning model, one or more model weights for training a client machine learning model in a plurality of client machine learning models, wherein each client machine learning model is associated with a respective client system.

The system may include wherein each representation in the plurality of representations identifies one or more features of data in the respective dataset in the plurality of datasets, wherein the one or more features of the dataset includes at least one of the following: a type of data, a subtype of data, one or more identifiers of data, a metadata, and any combination thereof.

The system may include wherein filtering the combined representation, using at least one of: the one or more first and second parameters, includes removing at least one feature in one or more features not related to the learning query from the combined representation.

The system may include wherein one or more representations in the plurality of representations includes at least one of: a hierarchical representation, a catalog of data in the respective dataset and any combination thereof.

The system may include wherein filtering the combined representation includes filtering the combined representation using one or more first parameters associated with a type of data in the plurality of datasets identified by the learning query; and filtering, subsequent to the filtering performed using the one or more first parameters, the combined representation using one or more second parameters associated with a subject matter of data in the plurality of datasets identified by the learning query, and generating the filtered representation.

The system may include wherein the at least one processor is configured to provide the one or more model weights to the plurality of client machine learning models, wherein each client system is configured to train its client machine learning model using the one or more model weights.

In one aspect, a non-transitory computer-readable storage medium, the computer-readable storage medium including instructions that when executed by at least one processor, cause the at least one processor to: apply a machine learning model to a plurality of representations, generated by a publicly available machine learning model, to generate a combined representation of a plurality of datasets, wherein each dataset in the plurality of datasets is associated with a respective client system in a plurality of client systems, wherein data in each dataset is not provided to the machine learning model; filter, using the machine learning model, the combined representation by filtering the combined representation using one or more first parameters associated with a type of data in the plurality of datasets, wherein the one or more first filtering parameters are associated with a learning query, the learning query identifying at least one subject matter associated with data in the plurality of datasets; and filtering, subsequent to the filtering performed using the one or more first parameters, the combined representation using one or more second parameters associated with a subject matter of data in the plurality of datasets identified by the learning query, and generating the filtered representation; generate, using the machine learning model, one or more model weights for training a client machine learning model in a plurality of client machine learning models, wherein each client machine learning model is associated with a respective client system; and provide the one or more model weights to the plurality of client machine learning models, wherein each client system is configured to train its client machine learning model using the one or more model weights.

The non-transitory computer-readable storage medium may include wherein one or more representations in the plurality of representations includes at least one of: a hierarchical representation, a catalog of data in the respective dataset and any combination thereof.

Any of the computing apparatus examples given above may also be implemented as means plus function examples. Other technical features may be readily apparent to one skilled in the art from the following figures, descriptions, and claims.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A computer-implemented method, comprising:
receiving, using at least one processor, a plurality of representations of a plurality of datasets from a plurality of client systems, a representation in the plurality of representations corresponds to a dataset associated with a client system in the plurality of client systems, wherein each representation in the plurality of representations is generated using a first machine learning model;
applying, using the at least one processor, a second machine learning model to the plurality of representations to generate a combined representation of the plurality of datasets, wherein data from each dataset in the plurality of datasets is not provided to the second machine learning model;
filtering, using the at least one processor, using the second machine learning model, the combined representation using one or more filtering parameters to generate a filtered representation, wherein the one or more filtering parameters are associated with a learning query, the learning query identifying at least one subject matter associated with data in the plurality of datasets;
generating, using the at least one processor, using the second machine learning model, one or more model weights for training a third machine learning model in a plurality of third machine learning models, wherein each third machine learning model is associated with a respective client system; and
providing, using the at least one processor, the one or more model weights to the plurality of third machine learning models.

2. The method of claim 1, wherein each representation in the plurality of representations identifies one or more features of data in the respective dataset in the plurality of datasets.

3. The method of claim 2, wherein the one or more features of the dataset includes at least one of the following: a type of data, a subtype of data, one or more identifiers of data, a metadata, and any combination thereof.

4. The method of claim 3, wherein the filtering using at least one of: the one or more first and second parameters includes removing at least one feature in one or more features not related to the learning query from the combined representation.

5. The method of claim 1, wherein one or more representations in the plurality of representations includes a hierarchical representation.

6. The method of claim 1, wherein one or more representations in the plurality of representations includes a catalog of data in the respective dataset.

7. The method of claim 1, wherein the first machine learning model is a publicly available machine learning model.

8. The method of claim 1, wherein the filtering includes filtering the combined representation using one or more first parameters associated with a type of data in the plurality of datasets identified by the learning query.

9. The method of claim 8, wherein the filtering includes filtering, subsequent to the filtering performed using the one or more first parameters, the combined representation using one or more second parameters associated with a subject matter of data in the plurality of datasets identified by the learning query, and generating the filtered representation.

10. The method of claim 1, wherein each client system is configured to train its third machine learning model using the one or more model weights.

11. The method of claim 1, wherein at least one of the first, second and third machine learning models include at least one of the following: a generative artificial intelligence (AI) model, a large language model, and any combination thereof.

12. The method of claim 1, wherein the data in one or more datasets in the plurality of datasets includes at least one of: a legal document, a non-legal document, an agreement, a text, an image, a graphic, a video, an audio, a clause in the electronic document, a sentence in the electronic document, a paragraph in the electronic document, a predetermined number of characters in the electronic document, and any combination thereof.

13. A system, comprising:
at least one processor; and
at least one memory storing instructions that, when executed by the at least one processor, cause the at least one processor to:
apply a machine learning model to a plurality of representations, generated by a publicly available machine learning model, to generate a combined representation of a plurality of datasets, wherein each dataset in the plurality of datasets is associated with a respective client system in a plurality of client systems, wherein data in each dataset is not provided to the machine learning model;
filter, using the machine learning model, the combined representation using one or more filtering parameters to generate a filtered representation, wherein the one or more filtering parameters are associated with a learning query, the learning query identifying at least one subject matter associated with data in the plurality of datasets; and
generate, using the machine learning model, one or more model weights for training a client machine learning model in a plurality of client machine learning models, wherein each client machine learning model is associated with a respective client system.

14. The system of claim 13, wherein each representation in the plurality of representations identifies one or more features of data in the respective dataset in the plurality of datasets, wherein the one or more features of the dataset includes at least one of the following: a type of data, a subtype of data, one or more identifiers of data, a metadata, and any combination thereof.

15. The system of claim 14, wherein filtering the combined representation, using at least one of:
the one or more first and second parameters, includes removing at least one feature in one or more features not related to the learning query from the combined representation.

16. The system of claim 13, wherein one or more representations in the plurality of representations includes at least one of: a hierarchical representation, a catalog of data in the respective dataset and any combination thereof.

17. The system of claim 13, wherein filtering the combined representation includes
filtering the combined representation using one or more first parameters associated with a type of data in the plurality of datasets identified by the learning query; and
filtering, subsequent to the filtering performed using the one or more first parameters, the combined representation using one or more second parameters associated with a subject matter of data in the plurality of datasets identified by the learning query, and generating the filtered representation.

18. The system of claim 13, wherein the at least one processor is configured to provide the one or more model weights to the plurality of client machine learning models, wherein each client system is configured to train its client machine learning model using the one or more model weights.

19. A non-transitory computer-readable storage medium, the computer-readable storage medium including instructions that when executed by at least one processor, cause the at least one processor to:
apply a machine learning model to a plurality of representations, generated by a publicly available machine learning model, to generate a combined representation of a plurality of datasets, wherein each dataset in the plurality of datasets is associated with a respective client system in a plurality of client systems, wherein data in each dataset is not provided to the machine learning model;
filter, using the machine learning model, the combined representation by
filtering the combined representation using one or more first parameters associated with a type of data in the plurality of datasets, wherein the one or more first filtering parameters are associated with a learning query, the learning query identifying at least one subject matter associated with data in the plurality of datasets; and
filtering, subsequent to the filtering performed using the one or more first parameters, the combined representation using one or more second parameters associated with a subject matter of data in the plurality of datasets identified by the learning query, and generating the filtered representation;
generate, using the machine learning model, one or more model weights for training a client machine learning model in a plurality of client machine learning models, wherein each client machine learning model is associated with a respective client system; and
provide the one or more model weights to the plurality of client machine learning models, wherein each client system is configured to train its client machine learning model using the one or more model weights.

20. The non-transitory computer-readable storage medium of claim 19, wherein one or more representations in the plurality of representations includes at least one of: a hierarchical representation, a catalog of data in the respective dataset and any combination thereof.
